(19) United States
(12) Patent Application Publication
(10) Pub. No.: US 2026/0351098 A1
(43) Pub. Date: Nov. 5, 2026

(54) GENERATING CONTEXT-AWARE HAPTICS FOR MULTIMEDIA CONTENT

(71) Applicant: QUALCOMM Incorporated, San Diego, CA (US)

(72) Inventors: Vidya Sagar MARRI, Khammam (IN); Basid MOHAMMED, Hyderabad (IN); Anusha KOLAVENTI, Hyderabad (IN)

(21) Appl. No.: 19/195,521

(22) Filed: Apr. 30, 2025

(51) Int. Cl. G08B 6/00

(52) U.S. Cl. CPC G08B 6/00

(57) ABSTRACT

Aspects relate to generating context-aware haptics for multimedia content. A device includes one or more memories that store a sequence of frames associated with multimedia content and one or more processors coupled to the one or more memories. The one or more processors detect a context trigger associated with one or more frames in the sequence of frames, prior to a presentation of the one or more frames during playback of the multimedia content. The one or more processors generate a haptic control signal based on the detected context trigger. The one or more processors control, based on the generated haptic control signal, one or more haptic actuators to deliver a haptic effect. The haptic effect is aligned with the presentation of the one or more frames.

### BACKGROUND

### Field of the Disclosure

The present disclosure relates generally to haptics delivery, and, more particularly, to haptics delivery based on multimedia content.

### Description of Related Art

Multimedia devices (for example, smartphones, tablets, wearables, handheld media players, and similar portable electronics) may deliver audio and video content to users through streaming or locally stored media. These multimedia devices incorporate visual displays, audio output components, and various connectivity means (for example, wired connection or wireless connection) to support the playback of video, audio, games, interactive media, or the like.

Many multimedia devices either include haptic actuators or are coupled to external haptic components that generate haptic effects during use. The haptic effect, for example, vibrations or pulses, can simulate physical sensations. For example, a user may feel a vibration when typing on a virtual keyboard or a pulse when clicking an icon on a graphical user interface (GUI). Such haptic effect adds a tactile layer to the digital experience of the user. As demand for immersive and responsive user experience continues to grow, there are opportunities to improve haptic effect to enhance user engagement.

### SUMMARY

Aspects of the disclosure provide a device. The device includes one or more memories configured to store a sequence of frames associated with multimedia content. The device includes one or more processors coupled to the one or more memories. The one or more processors are individually or collectively configured to detect a context trigger associated with one or more frames in the sequence of frames, prior to a presentation of the one or more frames during playback of the multimedia content. The one or more processors are individually or collectively configured to generate a haptic control signal based on the detected context trigger, and control, based on the generated haptic control signal, one or more haptic actuators to deliver a haptic effect. The haptic effect is aligned with the presentation of the one or more frames.

In certain aspects, a device is provided. The device includes one or more haptic actuators. The device includes one or more memories configured to store a sequence of frames associated with multimedia content. The device includes one or more processors configured to detect a context trigger associated with one or more frames in the sequence of frames, prior to a presentation of the one or more frames during playback of the multimedia content. The one or more processors configured to generate a haptic control signal based on the detected context trigger, and actuate, based on the generated haptic control signal, at least one haptic actuator of the one or more haptic actuators. Based on the actuation, the at least one haptic actuator is configured to deliver a haptic effect that is aligned with the presentation of the one or more frames.

### BRIEF DESCRIPTION OF THE DRAWINGS

Various aspects of the present disclosure are illustrated by way of example, and not limited by the appended figures, in which like references indicate similar elements:

FIG. 1 is a block diagram that illustrates an example architecture of a media device with one or more haptic actuators integrated into the media device, in accordance with certain aspects of the present disclosure;

FIG. 2 is a block diagram that illustrates an example architecture of a media device configured to interface with a haptic output device comprising one or more haptic actuators, in accordance with certain aspects of the present disclosure.

FIG. 3 is a diagram that illustrates an example implementation of the media device of FIG. 1, in accordance with certain aspects of the present disclosure;

FIG. 4 is a diagram that illustrates an example implementation of the haptic output device of FIG. 2, in accordance with certain aspects of the present disclosure;

FIG. 5 is a diagram that illustrates an example scenario of delivering a context-aware haptic effect aligned with one or more frames of multimedia content, in accordance with certain aspects of the present disclosure;

FIGS. 6A and 6B are diagrams that illustrate example scenarios depicting modification of a baseline haptic profile based on one or more parameters of a detected context trigger, in accordance with certain aspects of the present disclosure;

FIG. 7A is a diagram that illustrates an example scenario depicting detection of a context trigger corresponding to a movement-based event and delivery of a directionally aligned haptic effect, in accordance with certain aspects of the present disclosure;

FIG. 7B is a diagram that illustrates an example scenario depicting generation of a context-aware haptic effect corresponding to an object depicted in one or more frames of multimedia content, in accordance with certain aspects of the present disclosure;

FIG. 7C is a diagram that illustrates an example scenario depicting detection of a context trigger corresponding to an impact event and delivery of a corresponding haptic effect, in accordance with certain aspects of the present disclosure;

FIG. 8 is a diagram that illustrates an example scenario for delivering context-aware haptic effects based on an interaction state and engagement of a user with an interface region, in accordance with certain aspects of the present disclosure;

FIGS. 9A and 9B are diagrams that illustrate example scenarios for selectively delivering a haptic effect based on a detected context trigger, in accordance with various aspects of the present disclosure;

FIG. 10 is a diagram that illustrates an example scenario of an interface configured to provide user-accessible options for modification of one or more attributes for haptics generation, in accordance with an embodiment of the present disclosure;

FIG. 11 is a diagram that illustrates an example of a system for implementing context-aware haptics, in accordance with certain aspects of the present disclosure;

FIG. 12 is a flowchart that illustrates a method (e.g., a process) for delivering context-aware haptics for multimedia content, in accordance with certain aspects of the present disclosure;

FIG. 13 is a flowchart that illustrates a method (e.g., a process) for delivering context-aware haptics for multimedia content based on an engagement of a user and an interface region, in accordance with certain aspects of the present disclosure;

FIG. 14 is a flowchart that illustrates a method (e.g., a process) for adjusting sensitivity of haptics generation through a graphical user interface, in accordance with certain aspects of the present disclosure;

FIG. 15 is a flowchart that illustrates a method (e.g., a process) for modifying a baseline haptic profile for context-aware haptics generation, in accordance with various aspects of the present disclosure; and

FIG. 16 is a flowchart that illustrates a method (e.g., a process) for actuating at least one haptic actuator, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and a method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, any magnetic storage devices, combinations of the aforementioned types of computer-readable media, or any medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and any suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Multimedia devices (for example, smartphones, tablets, wearables, handheld media players, and similar portable electronics) may deliver audio and video content to users through streaming or locally stored media. Many multimedia devices also use haptic actuators to deliver haptic effect during use. For example, a haptic effect may be delivered in response to a user interacting with a touch-enabled display. The haptic effect in multimedia devices is either triggered by direct user interaction (for example, tapping a button or selecting an on-screen icon) or is preprogrammed into specific content. Thus, if the multimedia being played does not include an associated haptic metadata file or embedded haptic cues, no additional haptic effect is generated. However, video content being played may include numerous moments, for example, during an on-screen impact, explosion, or a sudden movement, where the delivery of a haptic effect may enhance user experience. In the absence of such dynamic haptic effect, the tactile dimension of user experience remains underutilized.

To address the limitations of conventional multimedia devices, various aspects of the present disclosure provide a device configured to enable dynamic generation of context-aware haptics for multimedia content, even when the multimedia content does not include, or is not associated with, a haptic metadata file or embedded haptic cues. In many aspects, the device may include one or more memories and one or more processors coupled to the one or more memories. The one or more memories may be configured to store a sequence of frames associated with multimedia content (such as video content or audio-video content). The phrase “the one or more memories may be configured to store” may refer to either persistent storage or temporary/transient storage to enable multimedia playback on the device.

The one or more processors may be configured to detect a context trigger associated with one or more frames in the sequence of frames, prior to a presentation of the one or more frames during playback of the multimedia content. The context trigger may be associated with a movement-based event (e.g., a car driving, or the like), an object (e.g., a gun, etc.), an impact event (e.g., a crash or explosion, or the like), or a visual pattern (e.g., flashing lights, or the like) depicted in the one or more frames. Based on the detected context trigger, the one or more processors may be configured to generate a haptic control signal and control one or more haptic actuators to deliver a haptic effect that is aligned with the presentation of the one or more frames. The one or more processors may control the one or more haptic actuators based on the generated haptic control signal.

In an example scenario, the one or more frames that are yet to be presented may depict a car moving from left to right followed by a sudden collision. In such a scenario, the one or more processors may detect context triggers based on the movement-based event (e.g., the left to right movement) and the impact event (e.g., the collision) depicted in the one or more frames. Accordingly, the one or more processors may generate one or more haptic control signals based on the detected context triggers, and control the one or more haptic actuators, using the one or more haptic control signals, to deliver a haptic effect. As a result, the one or more haptic actuators may deliver (e.g., produce) a directional vibration (e.g., the haptic effect) that simulates the left to right movement of the car across a display of the device, followed by a sharp, high-intensity burst (e.g., the haptic effect) that simulates the sensation of collision. The directional vibration and the burst may be delivered in synchronization with a visual presentation of the one or more frames.

By enabling dynamic detection of context triggers directly from multimedia frames (e.g., the one or more frames), without explicit haptic annotations, the disclosed device may generate real-time, context-aware haptic effects for various multimedia content. Additionally, the synchronization of the haptic effect with the visual presentation of the one or more frames may enhance immersion and impact of the multimedia content, thus, delivering a more engaging user experience. Further, the device may support dynamic haptic generation for both locally stored multimedia content and streamed multimedia content, in real time or near real time.

In more aspects, the haptic control signal may indicate one or more attributes associated with the haptic effect. The one or more attributes may include, but are not limited to, an amplitude, a frequency, a duration, an intensity, a timing, or a spatial location of the haptic effect. For example, a haptic control signal generated in response to detection of a soft burst of light (e.g., a context trigger) may indicate an amplitude that results in a subtle vibration, whereas a haptic control signal generated in response to detection of a large-scale explosion (e.g., a context trigger) may indicate an amplitude that produces a forceful, impactful vibration. Similarly, a haptic control signal generated in response to a sharp, sudden event such as a gunshot or electrical discharge (e.g., a context trigger) may indicate a frequency that delivers a fast, tight oscillation pattern, while a haptic control signal generated in response to a ground rumble or heavy machinery (e.g., a context trigger) may encode a lower-frequency pattern to simulate a deeper, resonant vibration. In more examples, a haptic control signal generated in response to a discrete event (e.g., a context trigger) may deliver a short, pulse-like effect, whereas a haptic control signal generated in response to a continuous motion (e.g., a context trigger), such as a moving train, may deliver a sustained vibration that lasts for a longer duration than the pulse. Similarly, a haptic control signal generated in response to a minor interaction, such as a gentle bump or tap (e.g., a context trigger), may deliver a low-intensity haptic effect, whereas a haptic control signal generated in response to a significant impact, such as a crash or explosion (e.g., a context trigger), may deliver a high-intensity effect. Further, the timing attribute in the haptic control signal may enable the haptic effect to be aligned with the presentation of the one or more frames associated with the context trigger. Additionally, the spatial location attribute in the haptic control signal may indicate a delivery region of the haptic effect on the device, for example, delivering the haptic effect on a left side and progressing to a right in response to detecting a left-to-right movement in the one or more frames. The spatial location attribute may also identify which haptic actuator(s) to control in order to deliver the haptic effect. For example, the haptic control signal may control haptic actuators on a left side of the device first, followed by sequential control toward a right side, thereby simulating a motion across a surface of the device in alignment with the directional motion depicted in the one or more frames. Such spatial control of the haptic actuator(s) may allow the haptic effect to be delivered proximally to a location on the device where an event corresponding to the detected context trigger is depicted during the presentation of the one or more frames.

In various aspects, generation of the haptic control signal may be customized based on an interaction state between a user and an interface region associated with the one or more haptic actuators. In an example, if the one or more haptic actuators are included within the device, such as in a smartphone, a tablet, or a wearable, the interface region may correspond to an outer body or a housing of the device that the user touches or holds during use. In more examples, if the one or more haptic actuators are part of an external device, such as a haptic suit, a gaming controller, a haptic seat, or the like, the interface region may correspond to a part of the external device that comes into contact with a body of the user, such as grips of the controller, a seatback of the haptic seat, or a fabric of the haptic suit.

The interaction state may indicate how the user is interacting with the interface region. For example, in a case the device is a handheld device (e.g., a tablet, a smartphone, a wearable, or the like) that includes the one or more haptic actuators, the interaction state may indicate whether the user is gripping the device with one hand or two hands, the location of the fingers or palms in contact with the device, or the strength or consistency of the grip. In more examples, for external haptic components such as the haptic seat or the haptic suit, the interaction state may indicate which parts of the external haptic component are in contact with the body of the user.

In an example scenario, if sensor data (received from various sensors such as a touch sensor, accelerometer, gyroscope, or the like) indicates that the user is holding the device, including the one or more haptic actuators, with one hand, the one or more processors may selectively control only those haptic actuators that are positioned to deliver the haptic effect to a region of the device that is proximal to a contact position of the hand of the user. Conversely, if the sensor data indicates that the user is holding the device with both hands, the one or more processors may coordinate the control of the haptic actuators located near each hand of the user to deliver a more spatially distributed haptic effect.

In additional aspects, the controlling of the one or more haptic actuators to deliver the haptic effect may be customized based on an engagement between the user and the interface region. For example, if the sensor data, at one or more times corresponding to the presentation of the one or more frames, indicates that the interface region is engaged (such as in contact) with the user, the one or more processors may control the one or more haptic actuators to deliver the haptic effect. However, if at the one or more times corresponding to the presentation of the one or more frames, the one or more processors detect no engagement between the user and the interface region, the one or more processors may not provide the haptic control signal to the one or more haptic actuators. Such selective disabling of the haptic effect in the absence of the engagement between the user and the interface region may enable power savings by avoiding haptic actuator activation, thereby improving the overall energy efficiency of the device during playback of multimedia content.

In various aspects, the context trigger may be detected using trained artificial intelligence (AI)-based models. In an example, a library of reference context triggers and associated baseline haptic profiles may be stored in the one or more memories. When a detected context trigger exactly matches or partially matches a stored reference context trigger, the one or more processors may select the corresponding baseline haptic profile and then modify the selected haptic baseline profile based on parameters such as a motion vector, an intensity level, a duration, frequency characteristics, a rate of change, or proximity characteristics associated with the context trigger.

In an example scenario, the one or more processors may detect a context trigger corresponding to a vehicle collision depicted in the one or more frames. The detected context trigger may match a reference context trigger stored in a memory of the device, for example, associated with known collision-type events. The stored reference context trigger may be associated with a baseline haptic profile, which defines default parameters for how a collision should feel in terms of haptic effect (e.g., default amplitude, duration, and vibration pattern). Upon selecting this baseline haptic profile, the one or more processor may modify one or more parameters (for example, increasing the amplitude and shortening the duration based on a motion vector and intensity of the collision event) of the baseline haptic profile to more accurately simulate a tactile sensation of the detected collision. Thus, the generated haptic effect is allowed to be more contextually relevant and dynamically adapted to the unique properties of the detected context trigger. Moreover, adaptive modification of baseline haptic profiles may enable the device to create a wide range of haptic variations even for the same type of context trigger, based on how an event or object corresponding to the context trigger is visually or contextually depicted in the one or more frames. This not only increases the level of immersion but also enables the user to differentiate similar context triggers in a way that feels intuitive and engaging, enhancing the overall sensory experience of playback of multimedia content.

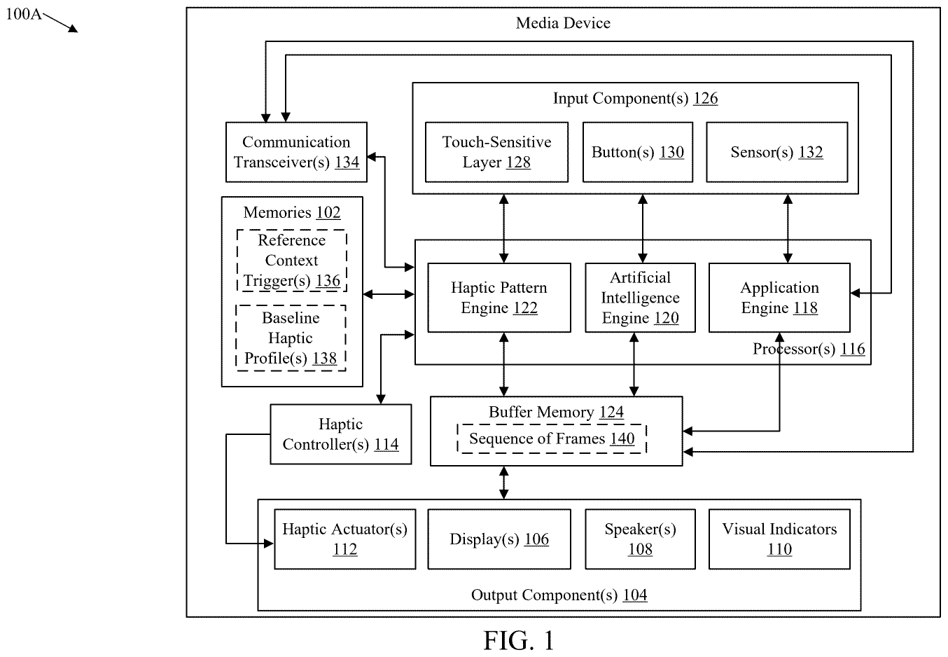

FIG. 1 is a block diagram that illustrates an example architecture of a media device 100A with one or more haptic actuators 112 integrated into the media device 100A, in accordance with certain aspects of the present disclosure. In various aspects, the media device 100A may have more or fewer components than illustrated in FIG. 1. In FIG. 1, the media device 100A is shown to include one or more memories 102, one or more output components 104, one or more haptic controllers 114, one or more processors 116, a buffer memory 124, one or more input components 126, and one or more communication transceivers 134.

In various aspects, the output component(s) 104 may include one or more displays 106. The display(s) 106 may be configured to display a sequence of frames 140 at different times across a period of time associated with playback of multimedia content. The sequence of frames 140 may include one or more frames that are yet to be presented. The multimedia content may include visual media content, for example, images, videos, presentations (e.g., slide decks, slide shows, sets of images), computer-generated imagery (CGI), or combinations thereof. In more examples, the multimedia content may be audio-video content.

In some aspects, the output component(s) 104 can also include one or more audio output devices (for example, one or more speakers 108) and one or more visual indicators 110, (for example, one or more light emitting elements). The media device 100A may play audio content of the multimedia content using the audio output device(s). Audio content may include, for example, sounds, music, tones, or combinations thereof. The media device 100A may provide feedback related to device status, notifications, or contextual events using the visual indicator(s) 110.

In various aspects, the output component(s) 104 may include the one or more haptic actuators 112. In a non-limiting example, the haptic actuator(s) 112 may include one or more actuators, one or more motors, one or more vibration motors, one or more vibration actuators, one or more eccentric rotating mass vibration motors (ERMs), one or more linear resonant actuators (LRAs), one or more linear resonant actuator (LRA) motors, one or more brushless motors, one or more direct current (DC) motors, one or more alternating current (AC) motors, one or more brushless DC (BLDC) motors, one or more haptic motors, one or more haptic actuators, one or more tactile feedback motors, one or more tactile feedback actuators, one or more vibration motors, one or more piezoelectric actuators, one or more piezoelectric motors, one or more piezo actuators, one or more piezo motors, one or more vibration actuators, one or more vibrators, one or more speakers that produce vibration-inducing audio, one or more buzzers that produce vibration-inducing audio, or a combination thereof. In some examples, the media device 100A may include multiple haptic actuators 112. In some examples, the media device 100A may include multiple haptic actuators 112, each positioned in a different region of the media device 100A. Actuation of a haptic actuator (e.g., any of the haptic actuator(s) 112) can cause the haptic actuator (and/or the media device 100A that the haptic actuator is a part of) to vibrate and/or move (e.g., rotate, slide, pulse, or create localized pressure), and thus deliver a haptic effect.

Haptic effect may refer to a tactile or kinesthetic feedback stimulus that is delivered (for example, to a user) through physical interaction with a surface (e.g., a body of the media device 100A), the media device 100A, or an object communicatively coupled to the media device 100A. Haptic effect may be delivered by one or more haptic actuators (e.g., the haptic actuator(s) 112) that convert electrical signals into mechanical movements, vibrations, or similar forms of physical output. Haptic effect may be delivered to convey sensory information, for example, movement, pressure, texture, impact, or spatial direction, to enhance sensory experience of the user. Haptic effect may simulate various sensations, such as short or long vibration pulses, localized feedback at a targeted spatial location, directional movement (e.g., left-to-right), surface textures, or impacts (e.g., collisions or explosions). In various implementations, haptic effect may be characterized by one or more attributes. In a non-limiting example, these attributes may include at least one of an amplitude, a frequency, a duration, a timing, an intensity, or a spatial location. The amplitude may represent the strength or magnitude of the haptic effect, while the frequency may define the rate or pitch of the haptic effect. Additionally, the intensity may refer to the perceived force or sharpness of the haptic effect. The duration may indicate how long the haptic effect is sustained, for example, whether the haptic effect is a brief pulse or a prolonged sensation. The timing attribute may specify when the haptic effect is triggered in relation to the playback of the multimedia content, such as being aligned with a specific frame and/or audio cue. The spatial location may refer to an area or a region of the media device 100A where the haptic effect is delivered, allowing for spatial or directional sensations.

In many aspects, the haptic actuator(s) 112 may be coupled to the haptic controller(s) 114. The haptic controller(s) 114 may be configured to receive haptic control signals or instructions from the processor(s) 116 to drive the haptic actuator(s) 112. The haptic controller(s) 114 may include hardware circuitry, such as motor driver(s) and/or actuator driver(s), breakout boards, or combinations thereof. In some examples, the haptic controller(s) 114 may turn at least one of the haptic actuator(s) 112 on or off based on the haptic control signals or the instructions from the processor(s) 116. In some examples, the haptic controller(s) 114 may increase, reduce, or zero out an amount of power provided to at least one of the haptic actuator(s) 112 based on the haptic control signals or the instructions from the processor(s) 116. In some examples, the haptic controller(s) 114 may increase, reduce, or zero out an intensity, strength, and/or amount of haptic effect (e.g., vibration) provided by at least one of the haptic actuator(s) 112 based on the haptic control signals or the instructions from the processor(s) 116. In some examples, the haptic controller(s) 114 may drive at least one of the haptic actuator(s) 112 to provide haptic effect based on the haptic control signals or the instructions from the processor(s) 116. In more examples, the haptic controller(s) 114 may translate the haptic control signals or the instructions from the processor(s) 116 into low-level drive signals, such as voltage, current waveforms, or the like, to actuate one or more specific haptic actuator(s) among the haptic actuator(s) 112.

Haptic control signal may refer to a signal generated by the processor(s) 116 and provided to the haptic controller(s) 114 to drive and control the operation of the haptic actuator(s) 112. In a non-limiting example, a haptic control signal may encode information to deliver a desired haptic effect on one or more surfaces of the media device 100A. In various implementations, the haptic control signal may indicate the one or more attributes, for example, an amplitude, a frequency, a duration, a timing, an intensity, a spatial location (e.g., which of the haptic actuator(s) 112 are to be actuated), or combinations thereof. In some examples, a haptic control signal may include temporal or spatial encoding that determines a sequence and distribution of haptic actuator activation to simulate motion or a directional sensation.

The buffer memory 124 may include one or more image buffers, frame buffers, display buffers, audio buffers, ring buffers, or a combination thereof. The buffer memory 124 may be configured to store portions of the multimedia content, including visual content and/or audio content, that are yet to be output by at least one of the output component(s) 104. In some examples, the buffer memory 124 may store the sequence of frames 140 that are scheduled for display or presentation using the display(s) 106, during the playback of the multimedia content. In many aspects, the stored sequence of frames 140 may correspond to multimedia content that is locally available on the media device 100A (for example, downloaded content or cached content stored in the one or more memories 102), or multimedia content that is streamed from a remote source (for example, over the Internet from a cloud-based streaming service), where buffering or temporary storage of at least a portion of the multimedia content may occur. In some examples, the buffer memory 124 may also store one or more audio clips that are to be played using the audio output device(s).

In various aspects, the input component(s) 126 may include one or more user interfaces and/or one or more components associated with the one or more user interfaces. The input component(s) 126 may include, in a non-limiting example, a touch-sensitive layer 128 (e.g., of a touchscreen and/or a trackpad), one or more buttons 130 (e.g., individual buttons, a keyboard, and/or a keypad, a mouse, a digitizer, a joystick, or a game controller), or combinations thereof. The input component(s) 126 may also include one or more sensors 132. Examples of the sensor(s) 132 may include one or more cameras, image sensors, microphones, depth sensors, Hall sensors, accelerometers, gyroscopes, positioning receivers (e.g., global navigation satellite system “GNSS” receivers), inertial measurement units (IMUs), or combinations thereof. Depth sensors can include, for example, light detection and ranging (LiDAR) sensors, radio detection and ranging (RADAR) sensors, sound detection and ranging (SODAR) sensors, sound navigation and ranging (SONAR) sensors, time of flight (ToF) sensors, structured light sensors, stereoscopic cameras, touch sensors, proximity sensor, capacitive grip sensor or combinations thereof.

The media device 100A may receive one or more inputs from the input component(s) 126. In some examples, the inputs can be indicative of touch input positions along the touch-sensitive layer 128, cursor positions (e.g., associated with a mouse or the touch-sensitive layer 128), button presses of the button(s) 130 (e.g., virtual button presses of one or more virtual buttons, physical button presses of one or more physical buttons), sensor data captured by the sensor(s) 132, or combinations thereof. Examples of the sensor data may include, but are not limited to, one or more images, videos, audio clips, depth information (e.g., point clouds), motion information, acceleration information (e.g., from an accelerometer), orientation information (e.g., from a gyroscope), a contact position between a user and a surface or region of the media device 100A (e.g., from touch sensors), presence or absence of hands of the user near the media device 100A (e.g., from proximity sensor), hand placement or grip patterns (e.g., from capacitive grip sensor), or combinations thereof.

In many aspects, the processor(s) 116 may be configured to execute instructions stored in the one or more memories 102 (for example, a non-transitory computer-readable storage medium). The instructions can include instructions corresponding to an application engine 118, an artificial intelligence (AI) engine 120, and/or a haptic pattern engine 122, so that the processor(s) 116 may run the application engine 118, the AI engine 120, and the haptic pattern engine 122.

In some examples, the application engine 118 may include a media playback application, such as a video player, a native video playback application, or a streaming application that receives and presents audio-video content from a remote source (e.g., over-the-top “OTT” streaming services). In other examples, the application engine 118 may include a video game and/or an extended reality (XR) application. Examples of the XR application may include an augmented reality (AR) application, a virtual reality (VR) application, a mixed reality (MR) application, or a combination thereof. In many examples, the application engine 118 may be configured to generate at least a portion of an environment for presenting multimedia content, such as rendering video frames, playing back audio, and coordinating visual and auditory elements to enable seamless playback of multimedia content. In some examples, the processor(s) 116 may be configured to locally generate at least a portion of the sequence of frames 140, for example, using the application engine 118. The locally generated portion of the sequence of frames 140 may include video recordings captured using the sensor(s) 132 (e.g., cameras). The locally generated portion of the sequence of frames 140 may be stored temporarily or persistently in the buffer memory 124 to enable subsequent playback through the application engine 118. In various aspects, the AI engine 120 may be configured to train one or more AI models using training data.

In some non-limiting examples, the AI engine 120 may employ supervised learning techniques that use multimedia samples such as image frames or video sequences annotated with reference context triggers to train an AI model. In some examples, reference context triggers may correspond to identifiable events such as movement-based events, object events, impact events, visual patterns depicted within multimedia content, or the like. During training, the AI model may apply one or more algorithms, such as, but not limited to, feature extraction, object recognition, or motion analysis techniques, to extract discriminative features from the annotated multimedia samples. These features may include, for example, spatial and temporal descriptors, edge maps, object contours, motion vectors, texture patterns, semantic labels, or additional forms of content representation. The AI model may then associate the extracted features with corresponding annotated reference context triggers to form input-output training pairs. The AI model may use these input-output training pairs to learn statistical correlations or mappings between visual (or audio) features and the reference context triggers. The training process thus enables the AI model to recognize similar features in unannotated multimedia content and classify the recognized features into known context trigger categories (e.g., the reference context triggers).

It will be understood that the above-described implementation is merely an example, and that the AI engine 120 can also train the AI model(s) using different training techniques. For example, in some implementations, the AI engine 120 may leverage unsupervised learning techniques, in which the AI model(s) are trained on unannotated multimedia samples to discover underlying patterns, groupings, or clusters that may correspond to new or emerging types of context triggers. In certain implementations, semi-supervised learning may be employed, where a smaller set of labeled data is combined with a larger set of unlabeled data to improve training efficiency and generalization. Additionally, the AI engine 120 may utilize self-supervised learning techniques, few-shot learning, transfer learning, reinforcement learning, or the like, without deviating from the scope of the disclosure.

Once trained, the AI model(s) may be executed by the AI engine 120. The AI model(s) may receive, as input, data associated with multimedia content, the data being obtained from one or more of the application engine 118, the buffer memory 124, the sensor(s) 132, or combinations thereof. In some examples, the input data received by the AI model(s) may include one or more frames, of the sequence of frames 140, that are yet to be presented during the playback of the multimedia content. In response to the input data, the trained AI model(s) may be configured to detect context triggers associated with one or more objects, events, patterns, or sounds depicted within the input data. The AI engine 120 may be configured to implement one or more algorithms including, but not limited to, feature extraction, feature detection, feature recognition, object detection, object recognition, facial detection, facial recognition, person recognition, sound detection, sound recognition, optical character recognition, or other classification techniques using the trained AI model(s) to detect context triggers.

The trained AI model(s) used by the AI engine 120 may include, but are not limited to, one or more neural networks, such as convolutional neural networks (CNNs), time delay neural networks (TDNNs), deep neural networks (DNNs), autoencoders, deep belief networks (DBNs), recurrent neural networks (RNNs), long short-term memory networks (LSTMs), gated recurrent units (GRUs), spiking neural networks (SNNs), graph neural networks (GNNs), transformer-based models, or similar suitable neural network architectures. In some examples, the trained AI model(s) may include large language models (LLMs) or multimodal transformer models that are configured to process text, audio, and/or visual data. In certain examples, the AI engine 120 may also utilize retrieval-augmented generation (RAG) models, which combine a neural retriever component with a transformer-based generator to enhance contextual understanding from multimedia or external data sources. Additionally, the trained AI model(s) may include one or more machine learning classifiers, such as support vector machines (SVMs), random forests (RFs), k-nearest neighbors (KNN), decision trees, gradient boosting machines (GBMs), AdaBoost, Naive Bayes classifiers, logistic regression models, or combinations thereof.

In various aspects, the haptic pattern engine 122 may be configured to generate a haptic control signal based on a context trigger detected by the AI engine 120. For example, the haptic pattern engine 122 may receive from the AI engine 120, information related to the detected context trigger. The received information may indicate one or more parameters associated with the detected context trigger. Examples of the parameters may include, but not limited to, a motion-vector, a duration, an intensity level, a frequency characteristic, a rate of change, or a proximity characteristic associated with the detected context trigger. Based on the received information, the haptic pattern engine 122 may determine one or more attributes of a corresponding haptic effect, for example, an amplitude, a frequency, a duration, a timing, an intensity, or a spatial location, and generate a haptic control signal dynamically using, for example, a rule-based logic, signal synthesis techniques, or a generative model. In other examples, the haptic pattern engine 122 may modify or adapt a baseline haptic profile based on the one or more parameters associated with the detected context trigger to generate a haptic control signal. The resulting haptic control signal may then be provided to the haptic controller(s) 114 to control one or more of the haptic actuator(s) 112.

In many examples, the haptic pattern engine 122 may use the haptic controller(s) 114 to control at least one of the haptic actuator(s) 112, for example, for turning the haptic actuator(s) 112 on or off. In some examples, the haptic pattern engine 122 may use the haptic controller(s) 114 to actuate or disable at least one of the haptic actuator(s) 112. In some examples, the haptic pattern engine 122 can use the haptic controller(s) 114 to increase, reduce, or zero out the amount of power provided to at least one of the haptic actuator(s) 112. In some examples, the haptic pattern engine 122 can use the haptic controller(s) 114 to increase, reduce, or zero out an intensity, strength, and/or amount of haptic effect (e.g., vibration) delivered by at least one of the haptic actuator(s) 112. In some examples, the haptic pattern engine 122 can use the haptic controller(s) 114 to cause at least one of the haptic actuator(s) 112 to deliver a haptic effect according to a generated haptic control signal.

In various aspects, the processor(s) 116 may include any suitable type of processing unit capable of executing instructions stored in the memories 102. Examples of processor(s) 116 may include, but are not limited to, a central processing unit (CPU), a graphics processing unit (GPU), a neural processing unit (NPU), a reduced instruction set computer (RISC) processor, a complex instruction set computer (CISC) processor, a microcontroller unit (MCU), a digital signal processor (DSP), an application-specific integrated circuit (ASIC), a field-programmable gate array (FPGA), or an image signal processor (ISP). In some examples, the processor(s) 116 may include a combination of general-purpose and specialized processing components that collaboratively execute different aspects of the multimedia analysis, AI processing, haptic generation, or control tasks described herein.

In various aspects, the memories 102 may include one or more types of memory components, such as non-volatile memory (e.g., flash memory, read-only memory (ROM)), volatile memory (e.g., dynamic random-access memory “DRAM”, static RAM “SRAM”), cache memory, or combinations thereof. These memories 102 may be implemented as on-chip, embedded, or external memory components communicatively coupled with the processor(s) 116. In some examples, the buffer memory 124 may be implemented as a portion of the one or more memories 102, such as a designated region of volatile memory (e.g., DRAM), configured to temporarily store multimedia content, including the sequences of frames 140, audio data, or sensor inputs during playback or analysis of the multimedia content.

The memories 102 may be configured to store instructions that, when executed by the processor(s) 116, enable operation of various functional engines within the media device 100A, including the application engine 118, the AI engine 120, and the haptic pattern engine 122. In some examples, the application engine 118, the AI engine 120, and the haptic pattern engine 122 may operate in coordination to analyze the multimedia content during the playback, detect relevant context triggers, and generate corresponding haptic effects.

In addition to executable instructions, the one or more memories 102 may be configured to store a variety of runtime and supporting data used during the operation of the application engine 118, the AI engine 120, and the haptic pattern engine 122. Examples of the runtime and supporting data may include, but are not limited to, reference data structures, configuration parameters, pattern definitions, trained AI model parameters, feature extraction mappings, or classification rules. For example, the one or more memories 102 may store data that is learned during the training of the AI model(s), such as extracted features, annotated samples, or reference context trigger classifications. The stored data may also include preconfigured or programmed values, for example, baseline haptic profiles or predefined responses associated with known visual or auditory events.

As shown in FIG. 1, the one or more memories 102 may store a plurality of reference context triggers 136 and corresponding baseline haptic profiles 138. In many examples, the plurality of reference context triggers 136 may represent context triggers that are learned or used by the AI model(s) during training. In some examples, the plurality of reference context triggers 136 may be configured based on system parameters or application-specific implementations. In many examples, the plurality of reference context triggers 136 may represent data patterns, features, or indicators corresponding to known events (for example, movement-based events, impact events, visual patterns) or objects. The plurality of reference context triggers 136 may be utilized as reference points to detect similar events or objects in multimedia content, either as an exact or partial match. The presence of such a match in one or more frames of the multimedia content may be identified as a context trigger for generating a haptic effect (e.g., haptic feedback). For example, a reference context trigger may correspond to a known collision sequence that when depicted in one or more frames of the multimedia content, can prompt haptic effect. The plurality of baseline haptic profiles 138 may define default haptic responses for the plurality of reference context triggers 136, respectively. The plurality of baseline haptic profiles 138 may be obtained from a variety of sources, for example, training datasets used by the AI engine 120, configuration files, cloud-based updates, preloaded content libraries, or user-defined settings, enabling the media device 100A to dynamically respond to multimedia events in a context-aware manner.

In many aspects, a baseline haptic profile in the plurality of baseline haptic profiles 138 may encode default attributes defining how a haptic effect should be delivered for a corresponding reference context trigger. For example, the baseline haptic profile may include one or more attributes that characterize the haptic effect, such as an amplitude, a frequency, a duration, an intensity, or the like. In other words, the plurality of baseline haptic profiles 138 may serve as default templates that can be used directly or dynamically modified at runtime based on specific parameters associated with a context trigger detected at runtime.

In further aspects, the communication transceiver(s) 134 may include, but are not limited to, a Wireless Fidelity (WiFi) transceiver, a cellular transceiver (e.g., 3G, 4G, LTE, 5G), an ultra-wideband (UWB) transceiver, a 60 GHz transceiver, or a combination thereof. These communication transceiver(s) 134 may be configured to transmit haptic control signals or receive external context inputs for coordinating distributed or remote haptic effect. In some aspects, a remote system can provide at least a portion of the multimedia content to the media device 100A, which the media device 100A can receive via the communication transceiver(s) 134.

In an example scenario, the buffer memory 124 may store the sequence of frames 140 associated with multimedia content that is being played using the application engine 118. In an example, the sequence of frames 140 may correspond to a video segment depicting a car chase that culminates in a collision. The processor(s) 116 may be configured to analyze the sequence of frames 140, prior to the presentation of the sequence of frames 140 during the playback of the multimedia content. In an example, the processor(s) 116 may analyze the sequence of frames 140 using a computer vision-based AI model of the AI engine 120. The computer vision-based AI model may process visual information across the sequence of frames 140. Based on such analysis, the processor(s) 116 may detect a context trigger associated with one or more frames in the sequence of frames 140, prior to a presentation of the one or more frames. For example, the context trigger may correspond to a movement-based event (e.g., rapid left-to-right motion of a vehicle) and an impact event (e.g., sudden vehicle deformation indicating a collision).

Based on the detected context trigger, the processor(s) 116 may generate a haptic control signal. The processor(s) 116 may use the haptic pattern engine 122 to generate the haptic control signal. In an example implementation, the haptic pattern engine 122 may correspond to an on-device generative AI haptics model executed on an NPU, which may be configured to synthesize (or generate) a context-specific haptic waveform (e.g., the haptic control signal). In a scenario where the context trigger corresponds to a vehicle collision, the generated haptic waveform may include a directional vibration to simulate the movement of the vehicle followed by a short, high-intensity burst with sharp frequency modulation aligned to a timing of the frame depicting the collision. In other words, the haptic control signal may indicate one or more attributes of a desired haptic effect, for example, an amplitude, a frequency, a duration, a timing, an intensity, or a spatial location, based on the detected context trigger.

The processor(s) 116 may then control the haptic actuator(s) 112 based on the generated haptic control signal, for example, the haptic waveform, to deliver the desired haptic effect aligned with the presentation of the one or more frames. For example, the haptic pattern engine 122 may provide the generated haptic control signal to the haptic controller(s) 114 for controlling the haptic actuator(s) 112. The haptic controller(s) 114 may translate the haptic control signal into low-level drive signals to activate the haptic actuator(s) 112 based on the one or more attributes indicated in the haptic control signal. In some implementations, the haptic control signal may specify that a localized haptic effect is to be generated by actuating a specific subset of haptic actuators 112 associated with a region of the media device 100A. For example, the haptic control signal may indicate that a first haptic actuator is to be activated, while a second haptic actuator is to remain inactive, based on a spatial location within the one or more frames associated with the detected context trigger. Accordingly, if the spatial location indicates that the collision event may be rendered on a left portion of the display 106 during the presentation of the one or more frames, a haptic actuator among the haptic actuator(s) 112 positioned nearest to the left portion of the display 106 may be selectively actuated based on the haptic control signal to deliver a spatially aligned haptic effect.

In some examples, the haptic control signal may include temporal coding that corresponds to one or more times associated with the presentation of the one or more frames in which the context trigger is depicted. For example, the haptic waveform may include timing information aligned with frame timestamps associated with a collision or directional motion event, allowing the haptic effect to be delivered in real-time alongside the visual presentation of the one or more frames. In other words, the haptic control signal may enable the haptic actuator(s) 112 to deliver the haptic effect in temporal alignment with the presentation of the one or more frames, providing a synchronized and immersive tactile experience corresponding to the detected context trigger.

The term “processor(s) 116 may be configured to” or “the processor(s) 116 may” execute a function may encompass various aspects, including but not limited to: a single processor among the processor(s) 116 executing multiple functions; multiple processors among the processor(s) 116, each performing different aspect of the function independently; multiple processors among the processor(s) 116 operating in coordination to execute a function collectively; or any combination thereof, where different processors among the processor(s) 116 may dynamically (e.g., concurrently or sequentially) assume responsibilities based on system conditions. In various examples, the media device 100A may include a smartphone, a phablet, a tablet, a laptop, a game console, a handheld entertainment device, a wearable device, a media streaming device, or a head-mounted display (HMD) such as an AR headset, a VR headset, or an MR headset.

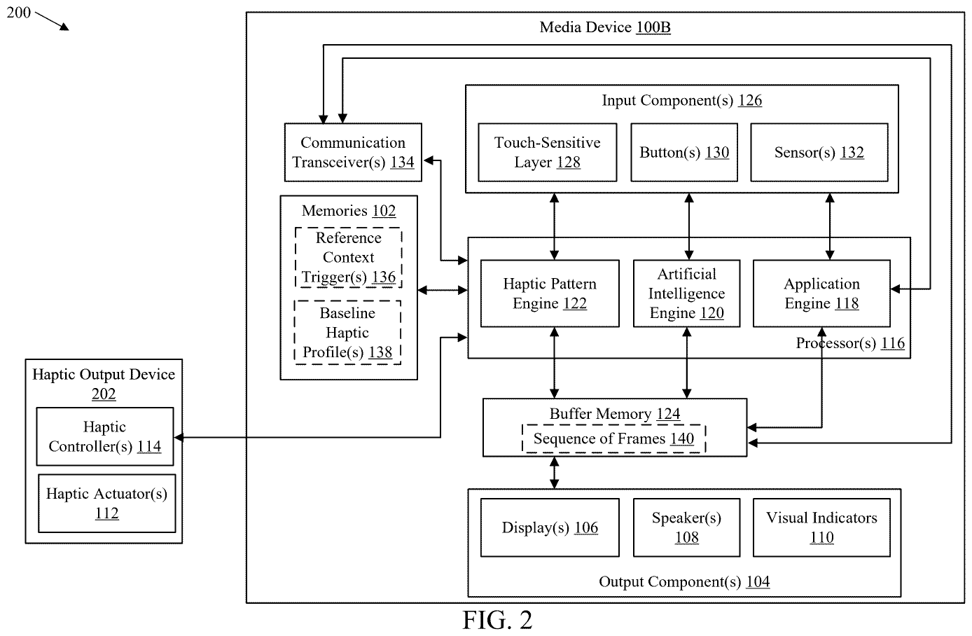

FIG. 2 is a block diagram that illustrates an example architecture 200 of a media device 100B configured to interface with a haptic output device 202 comprising one or more haptic actuators 112, in accordance with certain aspects of the present disclosure. In various aspects, the media device 100B may have more or fewer components than illustrated in FIG. 2. In an example implementation, the media device 100B may functionally correspond to the media device 100A of FIG. 1; however, instead of having the haptic actuator(s) 112 integrated within media device, the media device 100B is configured to communicate with a separate haptic output device 202 that includes the haptic actuator(s) 112 and one or more haptic controllers 114.

In FIG. 2, the media device 100B is shown to include the one or more memories 102, the one or more output components 104, the one or more processors 116, the buffer memory 124, the one or more input components 126, and the one or more communication transceivers 134 as described in the foregoing description of FIG. 1. The output component(s) 104 may include the one or more displays 106, the one or more speakers 108, and the one or more visual indicators 110 as described in the foregoing description of FIG. 1. The input component(s) 126 may include the touch-sensitive layer 128 (e.g., of a touchscreen and/or a trackpad), the one or more buttons 130 (e.g., individual buttons, a keyboard, and/or a keypad), a mouse, a digitizer, a joystick, a game controller, the one or more sensors 132, or combinations thereof as described in the foregoing description of FIG. 1. The processor(s) 116 may include the application engine 118, the AI engine 120, and the haptic pattern engine 122 as described in the foregoing description of FIG. 1. Further, the one or more memories 102 may store the plurality of reference context triggers 136 and the corresponding baseline haptic profiles 138 as described in the foregoing description of FIG. 1.

In various examples, the media device 100B may include a smartphone, a tablet, a laptop, a smart television, a game console, a set-top box, a media streaming device, or a head-mounted display (HMD) such as an AR headset, a VR headset, or an MR headset. In many examples, the haptic output device 202 may include a game controller, a wearable haptic suit or vest, a haptic glove, a haptic-enabled chair or seat, a haptic armband, or any other peripheral device equipped with the one or more haptic actuator(s) 112 and configured to receive haptic control signals from the media device 100B. In such examples, the haptic output device 202 may be communicatively coupled to the media device 100B via a wired or wireless communication link to deliver haptic effects based on context triggers detected during playback or interactive application use of multimedia content.

As shown in FIG. 2, the haptic actuator(s) 112 are not physically integrated into or on a housing of the media device 100B but are instead part of the separate haptic output device 202, which is coupled to the media device 100B via the communication link. The communication link may include a wired or wireless interface, such as Bluetooth®, Wi-Fi®, universal serial bus (USB), or other suitable protocols. The processor(s) 116 of the media device 100B may be individually or collectively configured to generate a haptic control signal (for example, a haptic waveform) based on a detected context trigger as described in the foregoing description of FIG. 1, and transmit the haptic control signal to the haptic output device 202 over the communication link. Upon receiving the haptic control signal, the haptic actuator(s) 112 in the haptic output device 202 may be activated to deliver the corresponding haptic effect. The haptic effect may be temporally aligned with the presentation of one or more frames of multimedia content rendered by the media device 100B. The one or more frames may be associated with the detected context trigger as described in the foregoing description of FIG. 1.

Additionally in the configuration illustrated in FIG. 2, even though the media device 100B does not include integrated haptic actuator(s) 112, the haptic effect can still be delivered through the external haptic output device 202. This enables the same haptic functionality described with respect to FIG. 1 to be realized in scenarios where media devices are devoid of haptic hardware. For example, a user viewing multimedia content on a television or a set-top box (as the media device 100B) may wear a haptic suit or vest (as the haptic output device 202), which receives haptic control signals over a communication link and delivers context-aware haptic effects aligned with the audiovisual experience. Such a configuration allows haptic effect to be incorporated into a wide variety of device ecosystems, including those where space, form factor, or design constraints may not allow for integrated haptic actuators.

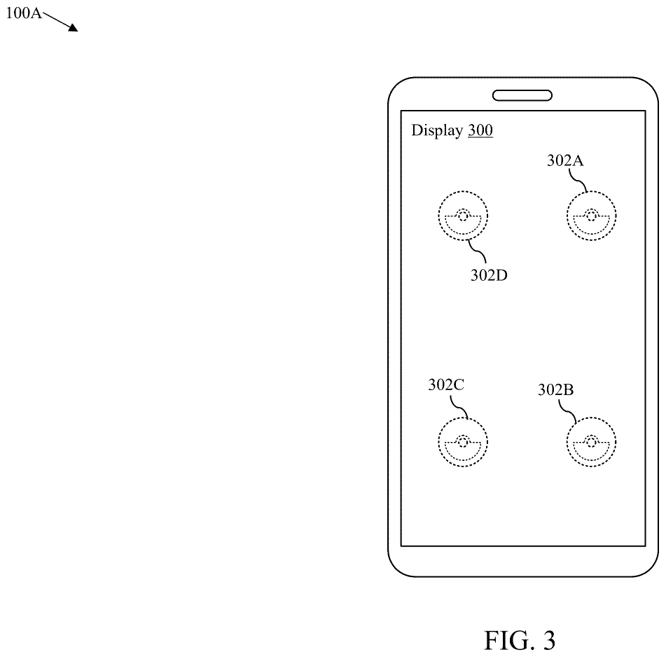

FIG. 3 is a diagram that illustrates an example implementation of the media device 100A, in accordance with certain aspects of the present disclosure. FIG. 3 is described in conjunction with FIG. 1. In a non-limiting example, the media device 100A is shown as a mobile device including a display 300 and a plurality of haptic actuators 302A, 302B, 302C, 302D (collectively referred to as “the haptic actuators 302A-302D”) in FIG. 3. The haptic actuators 302A-302D may be similar to the one or more haptic actuators 112 of the FIG. 1 and the display 300 may be similar to the display(s) 106 of FIG. 1. Although not explicitly shown in FIG. 3, the media device 100A of the FIG. 3 may also include the processor(s) 116 and the one or more memories 102, as described in the foregoing description of FIG. 1.

In some examples, the media device 100A may be configured to play back multimedia content, with the display 300 presenting a sequence of frames at different times across a period of time associated with the playback of the multimedia content. The sequence of frames (e.g., the sequence of frames 140 depicted in FIG. 1) may correspond to visual content included in the multimedia content. Additionally, the media device 100A may be configured to deliver localized and directional haptic effects using the haptic actuators 302A-302D. In the illustrated example, four haptic actuators 302A, 302B, 302C, and 302D are positioned near respective corners of the media device 100A.

The illustration of four haptic actuators depicted in FIG. 3 is provided solely for example purposes. In an actual implementation, the media device 100A may include a different number of haptic actuators, either fewer or greater than four, based on device design, application requirements, or specific user-experience goals.

In various aspects, the haptic actuators 302A-302D may be actuated individually or in combination based on a haptic control signal generated based on a detected context trigger associated with the sequence of frames (as described in the foregoing description of FIG. 1).

For example, if a context trigger corresponds to an event in a top-left portion of the display 300, such as an explosion or a vehicle appearing in the top-left portion, the haptic actuator 302A nearest to the top-left portion of the display 300 may be selectively actuated to deliver a spatially accurate and localized haptic effect. In other words, the delivered haptic effect may simulate a spatial sensation aligned with a spatial characteristic (e.g., the vehicle appearing in the top-left portion) associated with the detected context trigger.

In some examples, when a context trigger corresponds to an object moving from left to right across the display 300 (e.g., a directional characteristic), a composite haptic control signal may be generated to sequentially actuate haptic actuator(s) positioned on a left side of the media device 100A followed by haptic actuator(s) positioned on a right side of the media device 100A. The resulting haptic effect from such sequential actuation of the haptic actuators 302A-302D may simulate a directional sensation that is aligned with the directional characteristic.

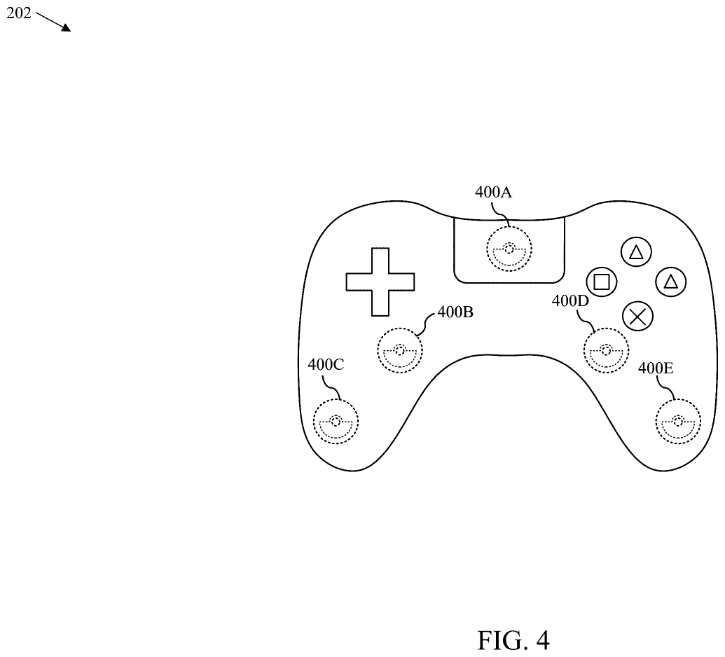

FIG. 4 is a diagram that illustrates an example implementation of the haptic output device 202, in accordance with certain aspects of the present disclosure. FIG. 4 is described in conjunction with FIGS. 1 and 2. In a non-limiting example, the haptic output device 202 is shown as a gaming controller including a plurality of haptic actuators 400A, 400B, 400C, 400D, 400E (collectively referred to as “the haptic actuators 400A-400E”) in FIG. 4. The haptic actuators 400A-400E may be similar to the one or more haptic actuators 112 of the FIG. 2. Although not explicitly shown in FIG. 4, the haptic output device 202 of the FIG. 4 may also include the haptic controller(s) 114 as described in the foregoing description of FIG. 2.

In many aspects, the haptic output device 202 may include multiple input components such as directional pads, buttons, and joysticks, and may be configured to receive and process haptic control signals for the purpose of delivering spatially distributed, context-aware haptic effects. As shown in FIG. 4, the haptic actuators 400A-400E may be positioned across various regions of the haptic output device 202, including grip portions, a central region, and button zones, where user contact is most frequent during the use of the haptic output device 202.

The illustration of five haptic actuators depicted in FIG. 4 is provided solely for example purposes. In an actual implementation, the haptic output device 202 may include a different number of haptic actuators, either fewer or greater than five, based on device design, application requirements, or specific user-experience goals.

In some implementations, the haptic output device 202 may be configured to communicate with a remote media device (for example, the media device 100B shown in FIG. 2 or the media device 100A shown in FIG. 1), which detects context triggers, generates haptic control signals, and transmits the haptic control signals via a communication link to the haptic output device 202. The context triggers may be associated with one or more frames of multimedia content or gameplay data and may correspond to, for example, a movement-based event, an object detection, an impact event, or a visual or auditory cue. The haptic output device 202 may include onboard haptic controller circuitry that interprets the received haptic control signals and actuates appropriate haptic actuators 400A-400E.

In various aspects, the haptic actuators 400A-400E may be actuated independently or in combination in response to haptic control signals received from the remote media device. In one example, when an explosion is detected in a lower-right region of a display, which is rendering a sequence of frames of the multimedia content, the haptic actuators 400D and 400E positioned near the right grip of the haptic output device 202 may be selectively actuated to simulate a spatially aligned haptic effect.

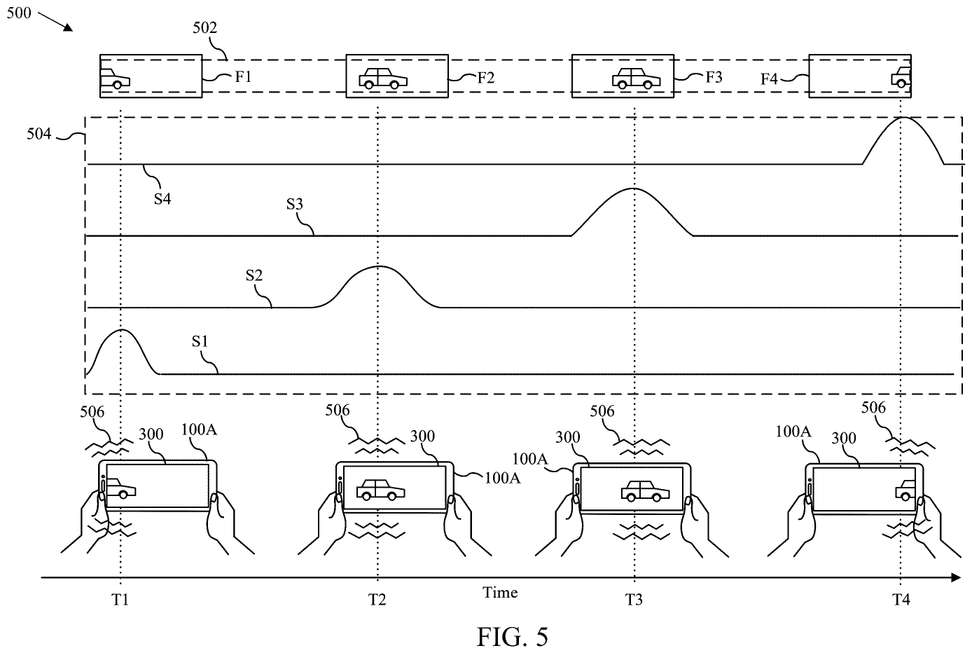

FIG. 5 is a diagram that illustrates an example scenario 500 of delivering a context-aware haptic effect aligned with one or more frames of multimedia content, in accordance with certain aspects of the present disclosure. FIG. 5 is described in conjunction with FIG. 1-4. FIG. 5 is shown to include the media device 100A as described in the foregoing description of FIG. 1. In an example, the media device 100A may include the processor(s) 116, the plurality of haptic actuators 302A-302D, and the display 300.

In the example scenario 500, frames F1, F2, F3, F4, included in the multimedia content, depict a car object at varying positions over time. These frames F1-F4 may be part of a sequence of frames stored in a buffer memory (e.g., the sequence of frames 140 stored in the buffer memory 124 of FIG. 1) of the media device 100A. Prior to presentation of the frames F1-F4 during playback of the multimedia content, the processor(s) 116 may analyze the frames F1-F4 (for example, using the AI engine 120 of FIG. 1) to determine whether the frames F1-F4 depict any event or object that can qualify as a context trigger for haptic generation.

In the example scenario 500, the processor(s) 116 may detect a context trigger 502 to be associated with the frames F1-F4. The context trigger 502 may correspond to a movement-based event, specifically, a car moving from left to right across a visual field as depicted in the frames F1-F4. In other words, the detected context trigger 502 is associated with a directional characteristic, for example, a left to right movement.

Based on the detected context trigger 502, the processor(s) 116 may generate a composite haptic control signal 504, prior to the presentation of the frames F1-F4 (for example, ahead of a scheduled presentation of the frames F1-F4). The composite haptic control signal 504 may include a set of subcomponents S1, S2, S3, and S4 that vary over time in terms of amplitude or other attributes (such as frequency, duration, timing, intensity, spatial location, or the like). In an example, each subcomponent S1, S2, S3, or S4 may correspond to a different spatial location of the media device 100A. The subcomponents S1, S2, S3, and S4 may indicate how the haptic actuators 302A-302D are to be selectively actuated at different times during the playback. For example, at an initial time (T1), only a left-side actuator may be activated due to a higher amplitude of the subcomponent S1, while other actuators may remain inactive. As the composite haptic control signal 504 progresses across time (from T1-T2, from T2-T3, and from T3-T4), the subcomponents S1, S2, S3, and S4 change in amplitude or intensity causing additional or different haptic actuators 302A-302D to activate, simulating the movement of the car from left to right as depicted in the frames F1-F4. In this way, the composite haptic control signal 504 encodes spatial, temporal, and directional attributes that can align a haptic effect with a visual trajectory depicted in the frames F1-F4.

During playback of the multimedia content, the display 300 may present the frames F1-F4 sequentially at time instances T1, T2, T3, and T4, respectively. The composite haptic control signal 504, generated prior to the presentation of the frames F1-F4, may be processed to deliver a corresponding haptic effect through the haptic actuators 302A-302D. Each subcomponent S1, S2, S3, and S4 of the composite haptic control signal 504 may trigger activation of different haptic actuators 302A-302D at corresponding time instances, based on the amplitude or intensity encoded in the subcomponents S1, S2, S3, and S4.

For example, at time T1, when the frame F1 is presented on the display 300 and the car is depicted on a leftmost side of the display 300, the subcomponent S1 may activate the haptic actuator 302A on the left side of the media device 100A. As the car progresses across the display 300 in the subsequent frames F2, F3, and F4, the subcomponents S2, S3, and S4 may activate additional or alternative haptic actuators 302A-302D positioned more toward the center or right side of the media device 100A. This selective actuation of different haptic actuators 302A-302D at different times across a playback duration of the multimedia content may cause a haptic effect (shown as a pattern 506 in FIG. 5) to be delivered. Moreover, the haptic effect may simulate a directional sensation that aligns with the directional characteristic of the detected context trigger 502, specifically, the left-to-right motion of the car. The directional sensation is indicated by the pattern 506 shifting from left to right, corresponding to the visual movement of the car across the display 300.

Thus, the haptic effect is delivered at one or more times T1, T2, T3, T4 across a period of time associated with the playback of the multimedia content and is aligned with the presentation of the frames F1-F4. The composite haptic control signal 504 may be used to control the actuation of the haptic actuators 302A-302D in real time or near real time in coordination with the presentation of corresponding frames F1-F4. In some examples, in addition to amplitude and spatial location, other attributes of the haptic effect such as intensity or duration can also be controlled by the composite haptic control signal 504 to reflect visual cues such as acceleration, increasing proximity, or visual prominence of the car object.

It will be appreciated that FIG. 5 is provided merely for illustrative purposes, and the representation of the composite haptic control signal 504 and the subcomponents S1, S2, S3, and S4 is a conceptual example. The composite haptic control signal 504 may be generated in any suitable form that enables haptic controller(s) (e.g., the haptic controller(s) 114 of FIG. 1) to selectively actuate the haptic actuators 302A-302D in a desired sequence. For example, the composite haptic control signal 504 may cause certain haptic actuators 302A-302D to remain inactive, while activating other haptic actuators 302A-302D with varying amplitudes, durations, or intensities. In one example, a first haptic actuator may be actuated to deliver a low-amplitude vibration, while a second haptic actuator may be actuated simultaneously or sequentially to deliver a higher amplitude vibration. The timing, order, and spatial configuration of haptic actuator activation may vary depending on a context trigger and attributes encoded in a haptic control signal, and are not limited to any specific waveform structure or temporal segmentation illustrated in FIG. 5.

Although FIG. 5 is described with reference to the media device 100A, a similar implementation may also be realized using the media device 100B in conjunction with the haptic output device 202, without departing from the scope of the present disclosure.

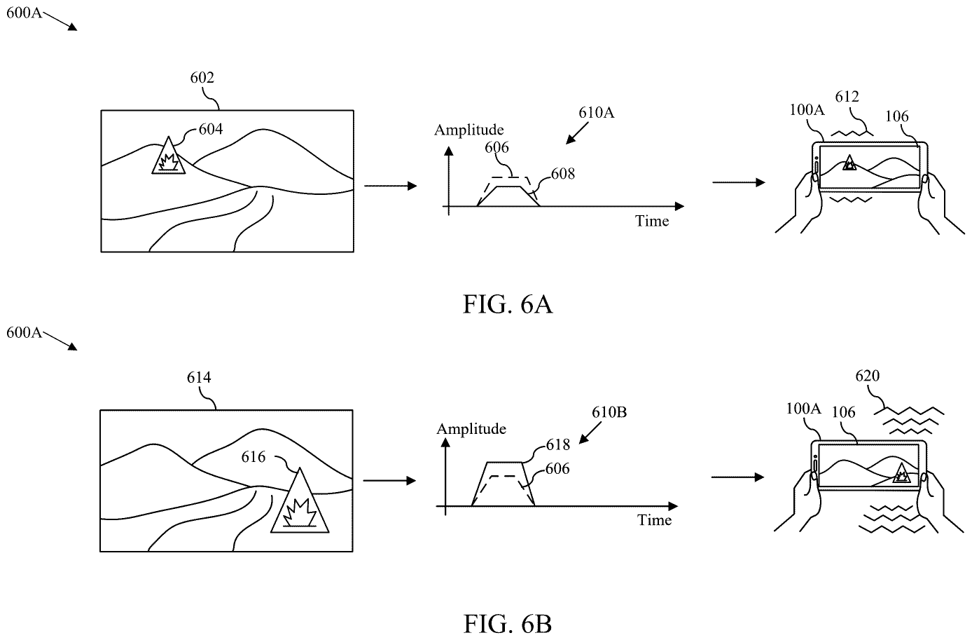

FIGS. 6A and 6B are diagrams that illustrate example scenarios 600A and 600B, respectively, depicting modification of a baseline haptic profile based on one or more parameters of a detected context trigger, in accordance with certain aspects of the present disclosure. FIGS. 6A and 6B are described in conjunction with FIG. 1-5. FIGS. 6A and 6B are shown to include the media device 100A. As described in the foregoing descriptions of FIGS. 1 and 3, the media device 100A may include the processor(s) 116, the haptic actuators 302A-302D, and the display 106.

Referring to FIG. 6A, in the example scenario 600A, a frame 602 is shown to include a graphical representation of a landscape scene in which an explosion event is depicted in the background, far from a perspective of a viewer. Prior to the presentation of the frame 602, the processor(s) 116 may analyze the frame 602 (e.g., using the AI engine 120) and detect the explosion as a context trigger 604. In this example, the detected context trigger 604 may include a spatial characteristic and a proximity characteristic indicating that the explosion in a left side region of the frame 602 is visually distant from the perspective of the viewer.

In response to detecting the context trigger 604, the processor(s) 116 may identify a reference context trigger (e.g., from the plurality of reference context triggers 136 stored in the one or more memories 102 of FIG. 1) that at least partially matches the detected explosion event. The processor(s) 116 may then select a baseline haptic profile (e.g., from the plurality of baseline haptic profiles 138) associated with the reference context trigger. Based on the proximity characteristic parameter of the detected context trigger 604 (for example, the explosion being far away), the processor(s) 116 may modify the selected baseline haptic profile. The modification of the baseline haptic profile may include a modification of one or more attributes (for example, at least one of an amplitude, a frequency, a duration, or an intensity) of the baseline haptic profile. As shown in an amplitude-time graph 610A in FIG. 6A, a dashed waveform 606 represents the unmodified baseline haptic profile, while a solid waveform 608 represents the modified baseline haptic profile with lower amplitude than the baseline haptic profile. The modified baseline haptic profile may correspond to the generated haptic control signal.

The generated haptic control signal is then used to control one or more of the haptic actuators 302A-302D that are positioned in a left side region of the media device 100A to deliver a corresponding haptic effect 612. As illustrated, when the frame 602 is presented on the display 106 of the media device 100A, a user may experience a low-intensity haptic effect 612 in the left side region of the media device 100A, which is consistent with the visual perception of the explosion occurring far in the background in the left side region of the frame 602.

In addition to the proximity or spatial parameters described in the context of FIG. 6A, a variety of additional or alternate parameters associated with the detected context trigger 604 may also be used to modify the baseline haptic profile before generating the haptic control signal. These parameters may include, but are not limited to, a motion vector, a duration, an intensity level, a frequency characteristic, and/or a rate of change associated with the detected context trigger 604.

In an example scenario, a detected context trigger may correspond to a fast-moving object traversing diagonally across the display 106 from a lower-left corner to an upper-right corner. In such a scenario, the detected context trigger may be associated with a motion vector indicating a high-speed diagonal trajectory. In response, a baseline haptic profile may be modified to include a directional vibration pattern that travels spatially across the media device 100A in the same diagonal direction captured by the motion vector, thereby aligning the haptic effect with the visual trajectory of the moving object.

In an example scenario, a detected context trigger may correspond to a continuous motion event, such as a train passing through a scene for an extended period. Based on the long duration associated with the motion event, the processor(s) 116 may modify a baseline haptic profile to extend an overall duration of the haptic effect, maintaining a continuous low-frequency rumble throughout the motion event.

In an example scenario, a detected context trigger may correspond to a vehicle accelerating rapidly. In such a scenario, the processor(s) 116 may determine a rate of change in motion between consecutive frames. In response, a baseline haptic profile may be modified to include a gradual increase in amplitude and frequency over a short period, creating a ramp-up sensation that mimics acceleration.

In an example scenario, a detected context trigger may correspond to a nearby explosion, with both intensity level and frequency characteristic higher than the explosion event described in FIG. 6A. In such a scenario, a baseline haptic profile corresponding to the detected context trigger may be modified by increasing an amplitude and incorporating sharp high-frequency bursts to simulate the perceived intensity and abruptness of the explosion.

Referring to FIG. 6B, in the example scenario 600B, a frame 614 is shown to include an explosion event in foreground of the frame 614 towards right side, closer to a visual perspective of the viewer. Prior to the presentation of the frame 614, the processor(s) 116 may analyze the frame 614 (e.g., using the AI engine 120) and detect the explosion event as a context trigger 616. In this example, the detected context trigger 616 may include a spatial characteristic and a proximity characteristic indicating that the explosion event in a right-side region of the frame 614 is visually close from the perspective of the viewer.

In response to detecting the context trigger 616, the processor(s) 116 may again retrieve the baseline haptic profile (shown as the dashed waveform 606) associated with the reference trigger (e.g., explosion event), but in this case, modify the baseline haptic profile based on a different value for the proximity characteristic parameter which indicates a near-field event. As a result, the amplitude (or intensity) of the baseline haptic profile is increased to generate a new haptic control signal, shown as a solid waveform 618 in an amplitude-time graph 610B of FIG. 6B. The solid waveform 618 may indicate a stronger and possibly longer-duration haptic effect, compared to the dashed waveform 606.

The modified haptic control signal is then used to control one or more of the haptic actuators 302A-302D that are in the right-side region of the media device 100A to deliver a high-intensity haptic effect 620 when the frame 614 is presented on the display 106. As shown, the media device 100A presents the frame 614 while simultaneously delivering the enhanced haptic effect 620.

Referring collectively to FIGS. 6A and 6B, the detected context triggers 604 and 616 both correspond to an explosion event but differ in parameters such as the spatial and proximity characteristics. Accordingly, although the same baseline haptic profile (represented by the dashed waveform 606) is initially selected, the processor(s) 116 may modify the attributes (e.g., amplitude, intensity, duration, or the like) of the selected baseline haptic profile differently for both context triggers 604 and 616 to generate different haptic control signals (represented by the solid waveforms 608 and 618). As a result, the haptic effect 620 delivered in the example scenario 600B is more intense than the haptic effect 612 delivered in the example scenario 600A, aligning with the relative visual proximity and spatial location of the depicted explosion events.

Although FIGS. 6A and 6B are described with reference to the media device 100A, a similar implementation may also be realized using the media device 100B in conjunction with the haptic output device 202, without departing from the scope of the present disclosure.

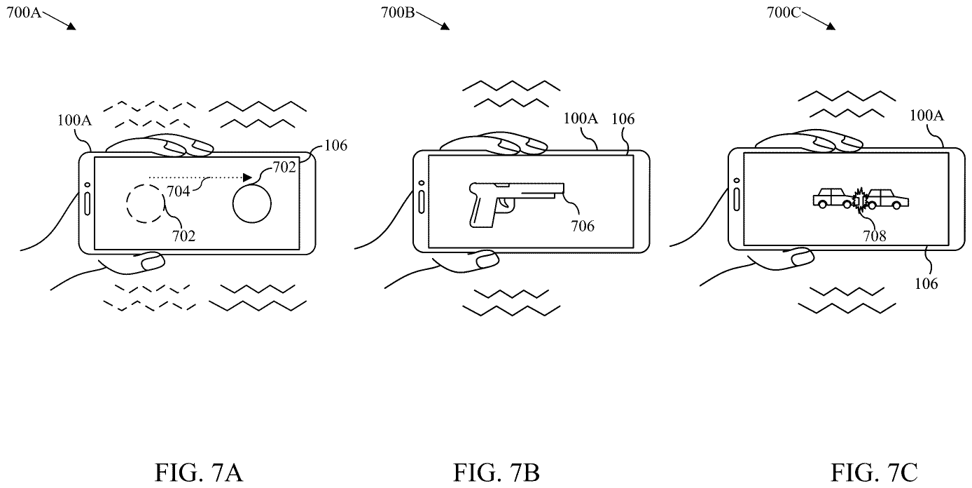

FIG. 7A is a diagram that illustrates an example scenario 700A depicting detection of a context trigger corresponding to a movement-based event and delivery of a directionally aligned haptic effect, in accordance with certain aspects of the present disclosure. FIG. 7A is described in conjunction with FIG. 1-4. The example scenario 700A is described using the media device 100A as an example. As described in the foregoing description of FIGS. 1 and 3, the media device 100A may include the processor(s) 116, the haptic actuators 302A-302D, and the display 106.

In the example scenario 700A, the media device 100A (such as a smartphone) is held by a user. The display 106 is shown to present a visual animation in which an object 702 transitions from an initial position (shown as a dashed outline on the left) to a final position (shown as a solid circle on the right) along a path 704. The path 704 indicates a motion vector of the object 702, demonstrating a left-to-right movement across the display 106.

In various aspects, the movement of the object 702 across the visual field is detected by the processor(s) 116 as a movement-based context trigger. The detection of the context trigger may be performed, for example, using the AI engine 120 of FIG. 1. The AI engine 120 may analyze a frame sequence depicting the movement-based event prior to presentation to determine spatial or directional changes in the multimedia content. Upon detecting the movement-based context trigger, the processor(s) 116 may generate a haptic control signal that encodes directional information reflecting the motion vector of the object 702.

The generated haptic control signal may be used to control or actuate one or more of the haptic actuators 302A-302D. At least one of the haptic actuators 302A 302D is actuated to deliver the haptic effect simulating a directional sensation. Wavy dashed lines on a left side of the media device 100A indicate the haptic effect delivered on the left side of the media device 100A when the object 702 is displayed at the left side (e.g., initial position) of the media device 100A. The wavy solid lines on a right side of the media device 100A indicates the haptic effect delivered on the right side of the media device 100A when the object 702 moves to the final position at the right side of the display 106.

FIG. 7B is a diagram that illustrates an example scenario 700B depicting generation of a context-aware haptic effect corresponding to an object depicted in one or more frames of multimedia content, in accordance with certain aspects of the present disclosure. FIG. 7B is described in conjunction with FIG. 1-4. The example scenario 700B is described using the media device 100A as an example. As described in the foregoing description of FIGS. 1 and 3, the media device 100A may include the processor(s) 116, the haptic actuators 302A-302D, and the display 106.

In the example scenario 700B, the media device 100A is being held by a user. The display 106 presents an object 706 (such as a gun). The presence of this specific object 706 (e.g., gun) within the one or more frames may be detected by the processor(s) 116 as a context trigger. The detection of the object 706 (such as the gun) may be based on various features such as shape, size, or object class present in the one or more frames. The detection of the context trigger may be performed, for example, using the AI engine 120 of FIG. 1. The AI engine 120 may analyze the one or more frames prior to presentation to detect various objects depicted in the one or more frames. Upon detecting the object-based context trigger, the processor(s) 116 may generate a haptic control signal that represents the detected object 706.

The generated haptic control signal may be used to control or actuate one or more of the haptic actuators 302A-302D. At least one of the haptic actuators 302A 302D is actuated to deliver the haptic effect. Wavy solid lines depicted in FIG. 7B indicate the haptic effect delivered when the object 706 is presented on the display 106.

FIG. 7C is a diagram that illustrates an example scenario 700C depicting detection of a context trigger corresponding to an impact event and delivery of a corresponding haptic effect, in accordance with certain aspects of the present disclosure. FIG. 7C is described in conjunction with FIG. 1-4. The example scenario 700C is described using the media device 100A as an example. As described in the foregoing description of FIGS. 1 and 3, the media device 100A may include the processor(s) 116, the haptic actuators 302A-302D, and the display 106.

In the illustrated example, the media device 100A, such as a smartphone, is being held by a user. The display 106 is shown to display a visual scene involving two vehicles colliding, represented as an impact event 708. The collision may be identified by the processor(s) 116 as a context trigger. A trained AI model (such as the AI engine 120) may enable detecting the presence of the impact event 708 through real-time analysis of one or more frames of the multimedia content ahead of a scheduled presentation of the one or more frames. Upon detecting the impact event 708, the processor(s) 116 may generate a haptic control signal configured to control one or more of the haptic actuators 302A-302D to deliver a haptic effect that simulates the sensation of the collision. Wavy solid lines depicted in FIG. 7C indicate the haptic effect delivered when the impact event 708 is presented on the display 106.

Although FIGS. 7A, 7B, and 7C are described with reference to the media device 100A, a similar implementation may also be realized using the media device 100B in conjunction with the haptic output device 202, without departing from the scope of the present disclosure.

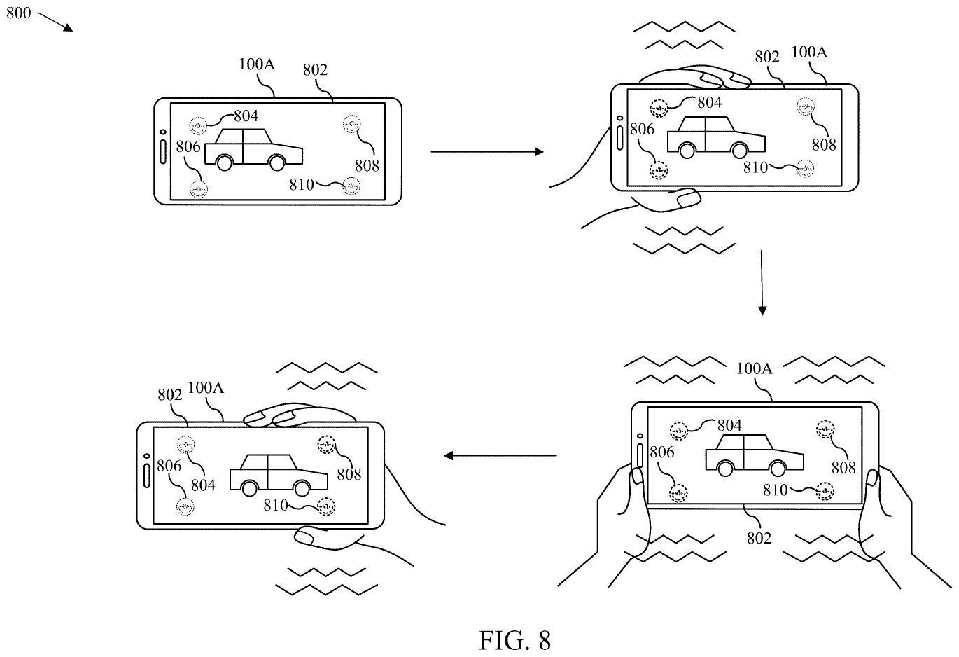

FIG. 8 is a diagram that illustrates an example scenario 800 for delivering context-aware haptic effects based on an interaction state and engagement of a user with an interface region, in accordance with certain aspects of the present disclosure. FIG. 8 is described in conjunction with FIG. 1-4. The example scenario 800 is described using the media device 100A as an example. Further, the media device 100A illustrated in FIG. 8 is shown to include a display 802, which may be similar to the display 106 of FIG. 1, and haptic actuators 804, 806, 808, and 810, which may be similar to the haptic actuator(s) 112 of FIG. 1. As described in the foregoing description of FIG. 1, the media device 100A may include the processor(s) 116.

In FIG. 8, the example scenario 800 illustrates how haptic effect may be selectively delivered through the haptic actuators 804, 806, 808, and 810 depending on how the user is physically engaging and interacting with the media device 100A during playback of the multimedia content. The illustration of four haptic actuators depicted in FIG. 8 is provided solely for example purposes. In an actual implementation, a different number of haptic actuators, either fewer or greater than four, based on device design, application requirements, or specific user-experience goals may be used.

The media device 100A (e.g., an interface region) is shown to include the haptic actuators 804, 806, 808, and 810 distributed across different regions of a housing of the media device 100A. For example, the haptic actuator 804 is positioned near top-left corner of the media device 100A, the haptic actuator 806 is positioned near lower-left corner of the media device 100A, the haptic actuator 808 is positioned near an upper-right corner of the media device 100A, and the haptic actuator 810 is positioned near a lower-right corner of the media device 100A. The haptic actuators 804, 806, 808, and 810 may be configured to deliver localized haptic effects in response to haptic control signals generated by the processor(s) 116.

The four illustrations in FIG. 8 depict different engagement and interaction states during playback of multimedia content. Playback of the multimedia content is depicted using a visual object, such as a car, presented on the display 802. Interaction state may indicate how the user is interacting with the media device 100A (e.g., the interface region) associated with the haptic actuators 804, 806, 808, and 810. For example, interaction state may indicate whether the user is gripping the media device 100A with one hand or two hands, a location of the fingers or palms in contact with the display 802, or a strength or consistency of the grip. In more examples, for external haptic components such as a haptic seat or a haptic suit, the interaction state may indicate which parts of the external haptic component are in contact with the body of the user.

In many aspects, the interaction state may be determined based on sensor data received from one or more sensors (e.g., the sensor 132 of FIG. 1) of the media device 100A. If the sensor data indicates that the user is holding the media device 100A with one hand, the interaction state may be “one-hand use”. Conversely, if the sensor data indicates that the user is holding the media device 100A with both hands, the interaction state may be “both-hand use”. In addition to the interaction state, the sensor data may also indicate the engagement between the media device 100A and the user, for example, whether the media device 100A is being held by the user, or is in a contact with the user. In some examples, the sensor data can also indicate no engagement between the user and the media device 100A. For example, when the media device 100A is resting on a surface and not in contact with the user, the sensor data may indicate an absence of engagement.

In top-left illustration of FIG. 8, the media device 100A is shown to be resting on a surface. In such a scenario, the sensor data may indicate an absence of engagement between the user and the media device 100A. As a result, the processor(s) 116 may disable haptic generation until engagement is detected.

In top-right illustration of FIG. 8, the media device 100A is held with one hand (e.g., left hand). In response to such interaction state (“one-hand use”), the processor(s) 116 may actuate a subset of the haptic actuators e.g., the haptic actuators 804 and 806, located nearest to the contact region of the media device 100A where the hand of the user is positioned, while keeping the haptic actuators 808 and 810 disabled. In such a scenario, a haptic control signal generated by the processor(s) 116 controls the haptic actuators 804 and 806 to deliver a haptic effect toward the contact region of the media device 100A (e.g., left side of the media device 100A) associated with active engagement.

In bottom-right illustration of FIG. 8, the media device 100A is held in both hands of the user. In response to such interaction state (“both-hand use”), the processor(s) 116 may actuate the haptic actuators 804, 806, 808, and 810, producing a more immersive and distributed haptic response across the entire surface of the media device 100A.

In the bottom-left illustration, the media device 100A is held with one hand (e.g., right hand). In response to such interaction state (“one-hand use”), the processor(s) 116 may actuate a subset of the haptic actuators e.g., the haptic actuators 808 and 810, located nearest to the contact region of the media device 100A where the hand of the user is positioned, while keeping the haptic actuators 804 and 806 disabled. In such a scenario, a haptic control signal generated by the processor(s) 116 controls the haptic actuators 808 and 810 to deliver a haptic effect toward the contact region of the media device 100A (e.g., right side of the media device 100A) associated with active engagement.

In various aspects, the processor(s) 116 may be configured to detect the interaction state and the engagement, and modify the delivery of the haptic effect accordingly. The haptic effect is delivered only in regions where the user is in contact with or is likely to perceive the vibration, thereby improving both energy efficiency and immersive user experience.

Although FIG. 8 is described with reference to the media device 100A, a similar implementation may also be realized using the media device 100B in conjunction with the haptic output device 202, without departing from the scope of the present disclosure.

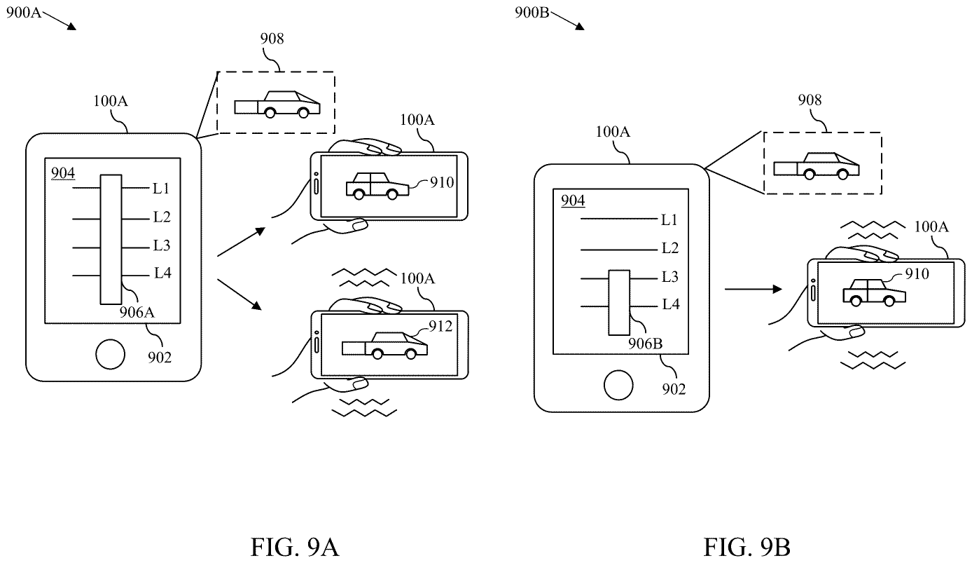

FIGS. 9A and 9B are diagrams that illustrate example scenarios 900A and 900B, respectively, for selectively delivering a haptic effect based on a detected context trigger, in accordance with various aspects of the present disclosure. FIGS. 9A and 9B are described in conjunction with FIG. 1-8. The example scenarios 900A and 900B are described using the media device 100A as an example. Further, the media device 100A illustrated in FIGS. 9A and 9B is shown to include a display 902, which may be similar to the display 106 of FIG. 1. As described in the foregoing description of FIGS. 1 and 3, the media device 100A may include the one or more memories 102, the processor(s) 116, and the haptic actuators 302A-302D.

Referring to FIG. 9A, the media device 100A may be configured to render a Graphical User Interface (GUI) 904 that includes a sensitivity adjustment control 906A. The sensitivity adjustment control 906A may enable multiple selectable sensitivity levels (for example, L1, L2, L3, L4), where level L1 may correspond to the highest sensitivity level and L4 may correspond to the lowest sensitivity level. In the illustrated example in FIG. 9A, the sensitivity level is set to the highest level L1.

In many aspects, the one or more memories 102 may store one or more reference context triggers. In an example, the stored reference context triggers may include a reference context trigger 908 representing a specific visual form of a truck and a baseline haptic profile associated with the reference context trigger 908.

During playback of multimedia content, the AI engine 120 (as shown in FIG. 1) may analyze one or more frames of the multimedia content ahead of presentation and attempt to detect one or more context triggers based on the stored reference context trigger 908. For example, the AI engine 120 may apply one or more computer vision techniques to extract a set of features from the visual content depicted in the one or more frames. The extracted features may include, but are not limited to, object shapes, edges, contours, motion vectors, texture patterns, color histograms, object bounding boxes, or spatial relationships between the objects. The extracted features may then be encoded into one or more feature representations (e.g., embeddings or descriptor vectors), which are compared to reference feature representations associated with the reference context trigger 908 stored in the one or more memories 102. The comparison between the extracted features and the stored reference features may be performed using one or more similarity metrics or distance functions, such as cosine similarity, Euclidean distance, structural similarity index (SSIM), or learned similarity through neural network models. Based on the comparison, the AI engine 120 may determine a similarity index that quantifies how closely the visual content in a current frame under analysis matches the stored reference context trigger 908. If the similarity index exceeds a threshold value defined for (or associated with) a currently selected sensitivity level (e.g., L1), the processor(s) 116 may determine that a context trigger has been detected in the one or more frames, and may proceed to select the baseline haptic profile associated with the matched reference context trigger 908 for generating a haptic control signal.

In the example scenario 900A, an object 910 is presented on the display 902 that only partially matches the stored reference context trigger 908. Further, the similarity index between the detected context trigger corresponding to the object 910 and the reference context trigger 908 may fail to exceed the threshold value associated with the selected high-sensitivity level L1. As a result, no haptic control signal is generated, and the media device 100A refrains from delivering any haptic effect when the object 910 is presented on the media device 100A.

In contrast, another object 912 may be detected that exhibits a high similarity to the reference context trigger 908. In an example, the similarity index between the detected context trigger corresponding to the object 912 and the reference context trigger 908 may exceed the threshold value associated with the selected high-sensitivity level L1. Since the similarity index exceeds the threshold value corresponding to the sensitivity level L1, the processor(s) 116 may determine a match, select the baseline haptic profile associated with the reference context trigger 908, and generate a corresponding haptic control signal. The processor(s) 116 may then use the haptic control signal to control one or more of the haptic actuator(s) 302A-302D to deliver a haptic effect (indicated by the wavy line pattern in FIG. 9A) synchronized with the presentation of the object 912 on the display 902.

Referring to FIG. 9B, in the example scenario 900B, the sensitivity setting has been changed to a lower sensitivity level (e.g., L3) via the sensitivity adjustment control 906B on the GUI 904. Reducing the sensitivity level from L1 to L3 may correspond to a relaxed (or reduced) threshold value for context trigger detection, enabling the AI engine 120 to recognize partial matches as valid context triggers.

Further, in the example scenario 900B, the same reference context trigger 908 and baseline haptic profile are stored in the one or more memories 102. During playback, the one or more frames depicting the object 910 are once again analyzed prior to presentation, and the AI engine 120 may evaluate a similarity index between a context trigger associated with the object 910 and the reference context trigger 908. In this scenario, although the match remains partial, the similarity index may exceed the reduced threshold value associated with the selected lower sensitivity level (e.g., L3).

Based on this evaluation, the processor(s) 116 may determine that the detected context trigger associated with the object 910 is a valid context trigger. As a result, the processor(s) 116 may select the baseline haptic profile associated with the reference context trigger 908. The baseline haptic profile may optionally be modified such as by adjusting the intensity, duration, or additional attributes based on parameters of the detected context trigger. A corresponding haptic control signal is then generated. The processor(s) 116 may use the generated haptic control signal to control one or more of the haptic actuator(s) 302A-302D to deliver a synchronized haptic effect, even in response to the partial match.

Referring collectively to FIGS. 9A and 9B, the example scenarios 900A and 900B illustrate that the selected sensitivity level may influence how strictly the processor(s) 116 compare detected context triggers to stored reference context triggers. At higher sensitivity levels (e.g., L1), the processor(s) 116 may require a near-exact match between the detected and reference context triggers in order to generate a haptic control signal. At lower sensitivity levels (e.g., L3 or L4), the processor(s) 116 may apply a more relaxed similarity threshold, allowing partial matches to be sufficient for the generation of the haptic control signal. This user-configurable sensitivity mechanism may provide adaptable control over the selectivity and responsiveness of context-aware haptic generation, enabling the media device 100A to better accommodate different usage scenarios, user preferences, and content types.

In some implementations, the processor(s) 116 (e.g., the AI engine 120) may continue to improve haptic generation over time through on-device training based on user feedback. For example, when a detected context trigger does not correspond to an exact match with any reference context trigger stored in the one or more memories 102, the AI engine 120 may associate the detected object with a nearest-match reference context trigger using similarity indexing. This approximation may be used to generate an initial haptic control signal based on the closest matching baseline haptic profile. Following playback of the multimedia content, or after specific scenes, the media device 100A may re-present selected portions of the multimedia content to the user along with the generated haptic effect. During or after such playback, the media device 100A may prompt the user to provide feedback related to the haptic experience, for example, whether the intensity, duration, or timing of the haptic effect felt too strong, too weak, too short, or too long. The feedback from the user may be collected via a user interface (e.g., a slider, rating, or touch input), and used to evaluate the alignment between the expectations of the user and the generated haptic control signal.

Upon receiving the user feedback, the processor(s) 116 may initiate a lightweight on-device training or fine-tuning process. For example, the feedback may be used as labeled data to adjust the parameters of the trained AI models of the AI engine 120, improve inference accuracy, or refine how the trained AI models select a baseline haptic profile. Over time, as the user interacts with more multimedia content and provides additional feedback, the trained AI models of the AI engine 120 become personalized to the perception and preferences of the user, allowing the media device 100A to deliver more accurate, satisfying, and context-aware haptic responses.

Although FIGS. 9A and 9B are described with reference to the media device 100A, a similar implementation may also be realized using the media device 100B in conjunction with the haptic output device 202, without departing from the scope of the present disclosure.

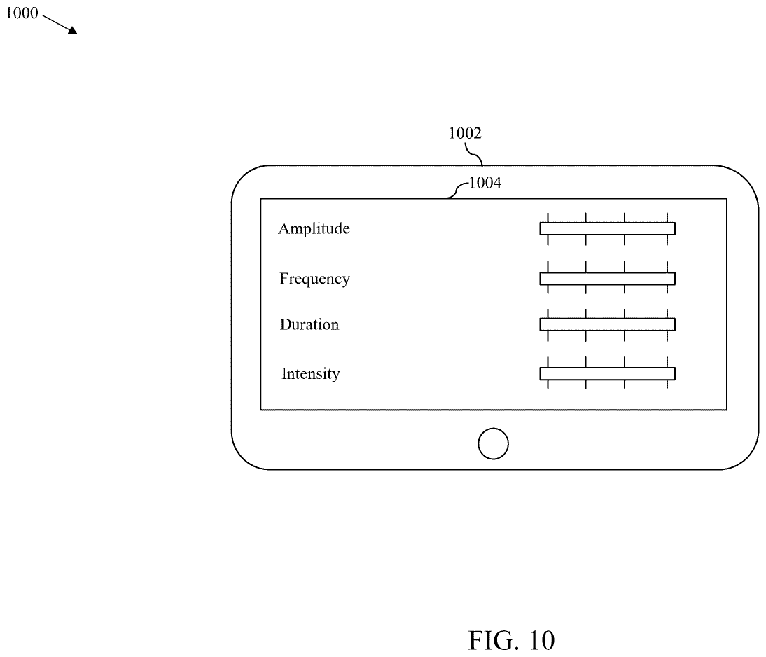

FIG. 10 is a diagram that illustrates an example scenario 1000 of an interface configured to provide user-accessible options for modification of one or more attributes for haptics generation, in accordance with an embodiment of the present disclosure. FIG. 10 is described in conjunction with FIG. 1-9B. A device 1002, shown in FIG. 10, may be similar to the media device 100A of FIG. 1 or the media device 100B of FIG. 2.

As shown in FIG. 10, the device 1002 includes a GUI 1004 that presents various attributes, for example, an “Amplitude” attribute, a “Frequency” attribute, a “Duration” attribute, and an “Intensity” attribute. Each of the attributes may be accompanied by a corresponding slider control. These attributes may represent characteristics of a haptic control signal, which are used to define how a haptic effect is delivered by one or more haptic actuators of the device 1002 or one or more haptic actuators communicatively coupled to the device 1002.

In various implementations, the GUI 1004 may allow a user to customize haptic effect generation by specifying preferred or maximum allowable values for each attribute. Providing programmable control over the attributes may enable personalized haptic experiences for the user. The settings of the attributes may be used by the haptic pattern engine 122 of FIGS. 1 and 2 during generation of the haptic control signal. As a result, generated haptic effects remain within user-defined constraints while still aligning with detected context triggers.

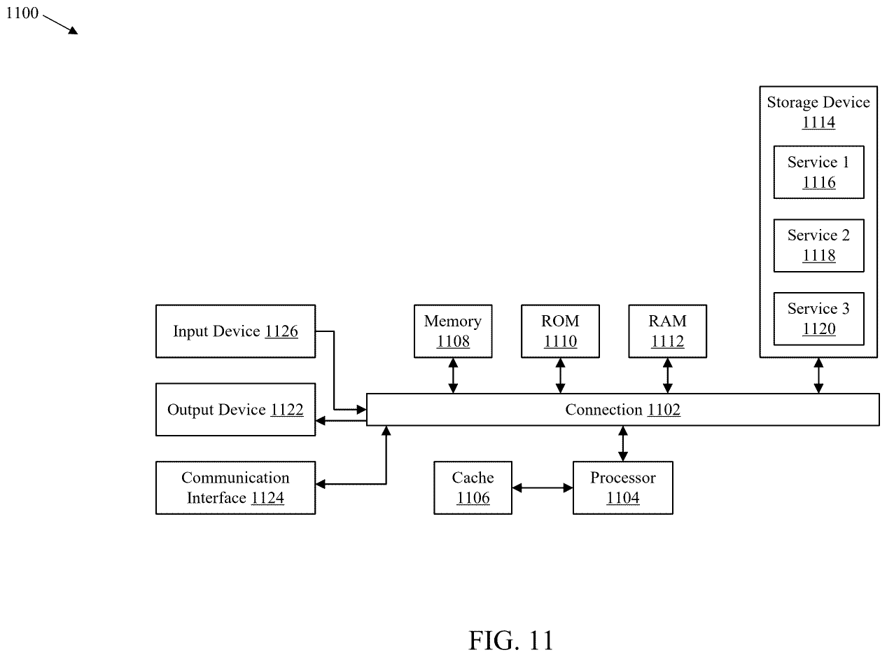

FIG. 11 is a diagram that illustrates an example of a system for implementing context-aware haptics, in accordance with certain aspects of the present disclosure. In particular, FIG. 11 illustrates an example of a computing system 1100, which can be for example any computing device making up internal computing system, a remote computing system, a camera, or any component thereof in which the components of the system are in communication with each other using a connection 1102. In some examples, the connection 1102 can be a physical connection using a bus, or a direct connection into processor 1104, such as in a chipset architecture. In certain examples, the connection 1102 can also be a virtual connection, networked connection, or logical connection.

In some embodiments, the computing system 1100 may be a distributed system in which the functions described in this disclosure can be distributed across multiple devices. In some embodiments, one or more of the described system components represent many such components each performing some or multiple functions for which the component is described. In some embodiments, the components can be physical or virtual devices.

The computing system 1100 may include at least one processor 1104 and the connection 1102 that couples various system components including a system memory 1108, a ROM 1110, and a RAM 1112 to the processor 1104. The computing system 1100 may also include a cache 1106 of high-speed memory connected directly with, in close proximity to, or integrated as part of the processor 1104.

The processor 1104 may include any general-purpose processor and a hardware service or software service, such as services 1116, 1118, and 1120 stored in a storage device 1114, configured to control the processor 1104 as well as a special-purpose processor where software instructions are incorporated into the actual processor design. The processor 1104 may be a completely self-contained computing system, containing multiple cores or processors, a bus, memory controller, cache, etc. A multi-core processor may be symmetric or asymmetric.

The computing system 1100 can also include output device 1122, which can be one or more of a number of output mechanisms. In some examples, multimodal systems can enable a user to provide multiple types of input/output to communicate with the computing system 1100. The computing system 1100 can include a communication interface 1124, which can generally govern and manage the user input and system output. The communication interface 1124 may perform or facilitate receipt and/or transmission wired or wireless communications using wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communication interface 1124 may also include one or more GNSS receivers or transceivers that are used to determine a location of the computing system 1100 based on receipt of one or more signals from one or more satellites associated with one or more GNSS systems. To enable user interaction, the computing system 1100 may include an input device 1126, which can represent any number of input mechanisms, such as a microphone for speech, a touch-sensitive screen for gesture or graphical input, keyboard, mouse, motion input, speech, etc.

The storage device 1114 may be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a subscriber identity module (SIM) card, a mini/micro/nano/pico SIM card, another integrated circuit (IC) chip/card, RAM, SRAM, DRAM, ROM, programmable read-only memory (PROM), EPROM, electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1114 can include software services, servers, services, etc., that executed by the processor 1104 causes the computing system 1100 to perform a function. In some embodiments, a hardware service that performs a particular function can include the software component stored in a computer-readable medium in connection with the necessary hardware components, such as the processor 1104, the connection 1102, the output device 1122, etc., to carry out the function.

In an example, the media device 100A of FIG. 1, the media device 100B of FIG. 2, the device 1002 of FIG. 10 may be implemented using the computing system 1100 without deviating from the scope of the disclosure.

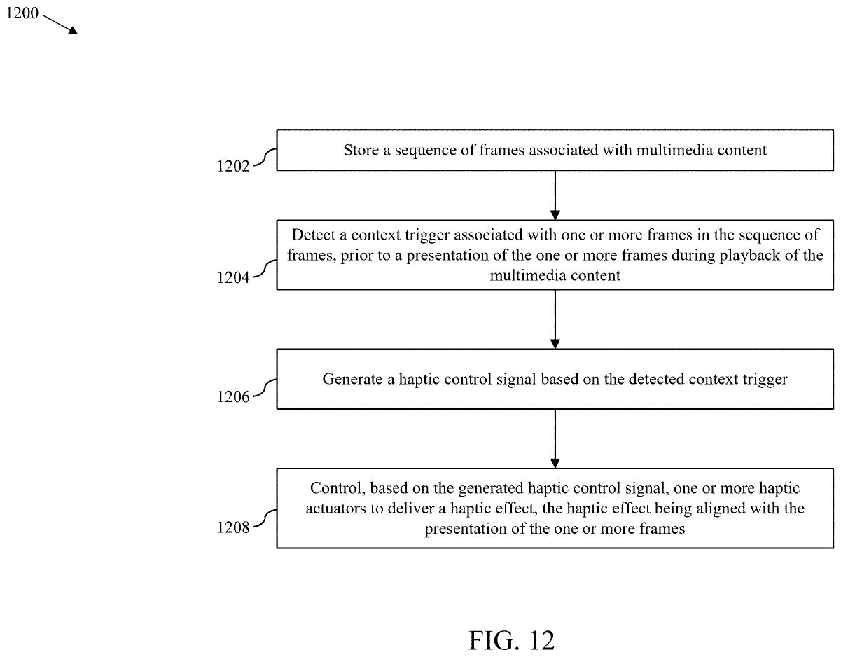

FIG. 12 is a flowchart that illustrates a method (e.g., a process 1200) for delivering context-aware haptics for multimedia content, in accordance with certain aspects of the present disclosure. FIG. 12 is described in conjunction with FIG. 1-11. Referring to FIG. 12, there is shown a process 1200 that illustrates various example operations 1202 through 1208 for delivering context-aware haptics for multimedia content. In a non-limiting example, the process 1200 is explained with reference to the media device 100A of FIG. 1.

At 1202, a sequence of frames associated with multimedia content may be stored in one or more memories of a device. The sequence of frames may include a series of video frames that depict visual elements such as moving objects, interactions, or events. The sequence frames may be obtained from a streaming source or stored locally, allowing the media device 100A to pre-process the multimedia content prior to playback.

At 1204, a context trigger associated with one or more frames may be detected in the sequence of frames, prior to a presentation of the one or more frames during playback of the multimedia content. The context trigger may correspond to specific features or events identified within the one or more frames, such as an object appearing, a motion transition, or an impact. For example, the processor(s) 116 may be individually or collectively configured to detect the context trigger associated with the one or more frames in the sequence of frames 140, prior to a presentation of the one or more frames during playback of the multimedia content. Detection of the context trigger by the processor(s) 116 is described in the foregoing description of FIG. 1-11.

At 1206, a haptic control signal may be generated based on the detected context trigger. The haptic control signal may define various haptic effect attributes, such as amplitude, frequency, duration, intensity, and optionally spatial direction. For example, the processor(s) 116 may be individually or collectively configured to generate the haptic control signal based on the detected context trigger. Generation of the haptic control signal by the processor(s) 116 is described in the foregoing description of FIG. 1-11.

At 1208, based on the generated haptic control signal, one or more haptic actuators may be controlled to deliver a haptic effect, the haptic effect being aligned with the presentation of the one or more frames. For example, the processor(s) 116 may be individually or collectively configured to control the haptic actuator(s) 112, based on the generated haptic control signal, to deliver the haptic effect. The haptic effect may be aligned temporally with the presentation of the one or more frames, ensuring that the haptic effect is delivered at the appropriate moment. Controlling of the haptic actuator(s) 112 to deliver the haptic effect is described in the foregoing description of FIG. 1-11.

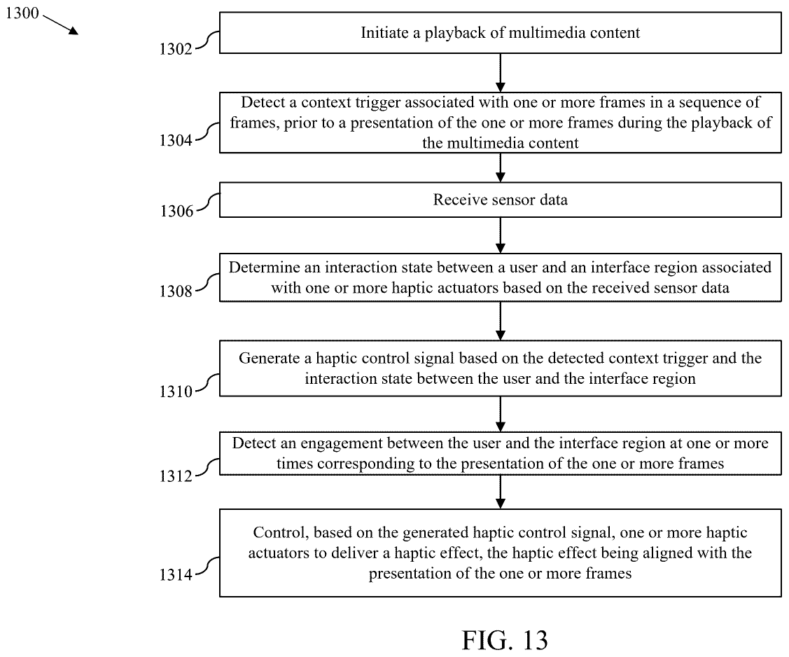

FIG. 13 is a flowchart that illustrates a method (e.g., a process 1300) for delivering context-aware haptics for multimedia content based on an engagement of a user and an interface region, in accordance with certain aspects of the present disclosure. FIG. 13 is described in conjunction with FIG. 1-12. Referring to FIG. 13, there is shown a process 1300 that illustrates various example operations 1302 through 1314 for delivering context-aware haptics for multimedia content. In a non-limiting example, the process 1300 is explained with reference to the media device 100A of FIG. 1

At 1302, playback of multimedia content may be initiated on a device. For example, the processor(s) 116 may be individually or collectively configured to initiate a playback of multimedia content on the media device 100A. The multimedia content may include a plurality of frames that may be presented at different times across a period of time associated with the playback of the multimedia content. In an example, a sequence of frames (e.g., the sequence of frames 140) of the plurality of frames may be stored in the buffer memory 124 prior to the presentation of the sequence of frames to enable the playback of the multimedia content.

At 1304, a context trigger associated with one or more frames in the sequence of frames may be detected, prior to a presentation of the one or more frames during the playback of the multimedia content. For example, the processor(s) 116 may be individually or collectively configured to detect the context trigger associated with the one or more frames in the sequence of frames 140, prior to the presentation of the one or more frames during the playback of the multimedia content. The context trigger may correspond to a movement-based event, an object, an impact event, a visual pattern, or a combination thereof depicted in the one or more frames. Detection of the context trigger by the processor(s) 116 is described in the foregoing description of FIG. 1-11.

At 1306, sensor data may be received. For example, the processor(s) 116 may be individually or collectively configured to receive the sensor data. In an example, the sensor data may be received from one or more sensors (e.g., the sensor(s) 132). Examples of the one or more sensors may include accelerometers, gyroscopes, touch sensors, capacitive grip sensors, proximity sensors, or the like. In an example, the sensor data may indicate at least one of a contact position between a user and an interface region associated with one or more haptic actuators or a grip pattern of the user. In an example, if the one or more haptic actuators are included within the device (e.g., the media device 100A), such as in a smartphone, a tablet, or a wearable, the interface region may correspond to an outer body or a housing of the device that the user touches or holds during the playback of the multimedia content. In more examples, if the one or more haptic actuators are part of an external device (e.g., the haptic output device 202 of FIG. 2), such as a haptic suit, a gaming controller, a haptic seat, or the like, the interface region may correspond to a part of the external device that comes into contact with a body of the user, such as grips of the controller, a seatback of the haptic seat, or a fabric of the haptic suit, during the playback of the multimedia content. In other words, the sensor data may indicate how the user interacts with the interface region (e.g., the media device 100A).

At 1308, an interaction state may be determined between the user and the interface region associated with the one or more haptic actuators based on the received sensor data. For example, the processor(s) 116 may be individually or collectively configured to determine the interaction state between the user and the interface region associated with the one or more haptic actuators (e.g., the haptic actuator(s) 112) based on the received sensor data. The interaction state may indicate which parts of the media device 100A are in contact with the hands of the user. The interaction state may indicate whether the media device 100A is held with one hand or both hands, or placed on a surface. For example, the processor(s) 116 may analyze the received sensor data indicating pressure distribution and touch patterns on the interface region, and determine whether the user is gripping the interface region firmly, loosely, or with a particular orientation such as one hand or both hands. Determination of the interaction state by the processor(s) 116 is described in the foregoing description of FIG. 1-11.

At 1310, a haptic control signal is generated based on the detected context trigger and the interaction state between the user and the interface region. For example, the processor(s) 116 may be individually or collectively configured to generate the haptic control signal based on the detected context trigger (e.g., a crash or explosion, or the like) and the interaction state (e.g., which parts of the interface region are in contact with the body of the user) between the user and the interface region. Generation of the haptic control signal by the processor(s) 116 is described in the foregoing description of FIG. 1-11.

At 1312, an engagement may be detected between the user and the interface region at one or more times corresponding to the presentation of the one or more frames. For example, the processor(s) 116 may be individually or collectively configured to detect the engagement between the user and the interface region at the one or more times corresponding to the presentation of the one or more frames. The one or more times may correspond to specific time instants (e.g., timestamps or temporal codes) across the period of time at which the one or more frames are scheduled for presentation during the playback of the multimedia content. Engagement may refer to whether the user is in physical contact with the interface region. Thus, detecting the engagement between the user and the interface region at the one or more times corresponding to the presentation of the one or more frames may include determining whether the user is in physical contact with the interface region. In an aspect, lack of contact may indicate disengagement between the user and the interface region. In an example, the processor(s) 116 may detect the engagement between the user and the interface region at the one or more times based on the sensor data received at the one or more times. The detection of the engagement between the user and the interface region by the processor(s) 116 is described in detail in the foregoing description of FIG. 1-11.

At 1314, the one or more haptic actuators may be controlled based on the generated haptic control signal to deliver a haptic effect, the haptic effect being aligned with the presentation of the one or more frames. For example, the processor(s) 116 may be individually or collectively configured to control, based on the generated haptic control signal, the haptic actuator(s) 112 to deliver the haptic effect responsive to the detection of the engagement between the user and the interface region. In other words, the processor(s) 116 may control the haptic actuator(s) 112 to deliver the haptic effect in a case the interface region associated with the haptic actuator(s) 112 is in physical contact with the user. Controlling of the haptic actuator(s) 112 to deliver the haptic effect is described in the foregoing description of FIG. 1-11.

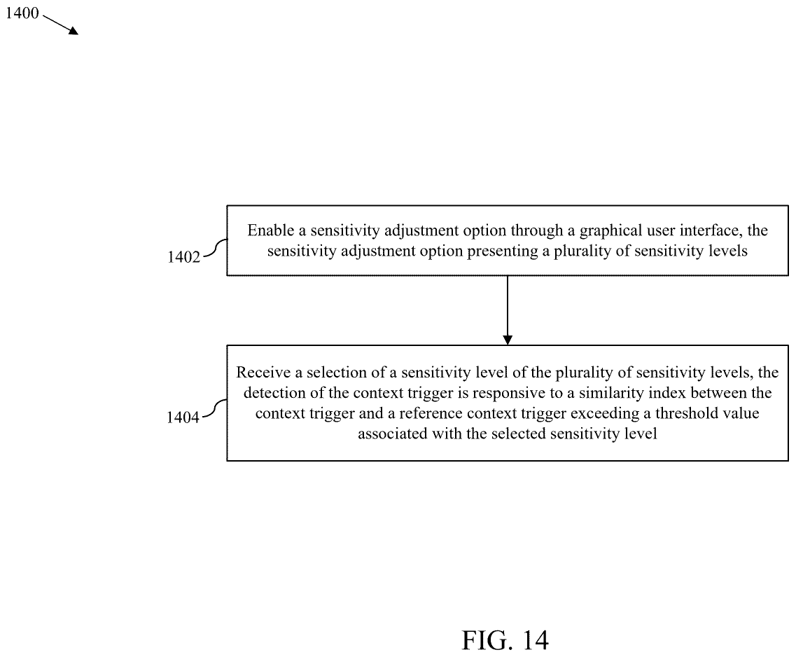

FIG. 14 is a flowchart that illustrates a method (e.g., a process 1400) for adjusting sensitivity of haptics generation through a GUI, in accordance with certain aspects of the present disclosure. FIG. 14 is described in conjunction with FIG. 1-13. Referring to FIG. 14, there is shown a process 1400 that illustrates various example operations 1402 through 1404 for adjusting sensitivity through a GUI. In a non-limiting example, the process 1400 is explained with reference to the media device 100A of FIG. 1

At 1402, a sensitivity adjustment option may be enabled through a GUI. The sensitivity adjustment option may present a plurality of sensitivity levels. For example, the processor(s) 116 may be individually or collectively configured to enable the sensitivity adjustment option through the GUI 904. As described in the foregoing description of FIGS. 9A and 9B, the sensitivity adjustment option may present the plurality of sensitivity levels L1 through L4 that are selectable, for example, through a user input. Enabling the sensitivity adjustment option through the GUI is described in the foregoing description of FIG. 1-11.

At 1404, a selection of a sensitivity level of the plurality of sensitivity levels may be received, the detection of the context trigger is responsive to a similarity index between the context trigger and a reference context trigger exceeding a threshold value associated with the selected sensitivity level. For example, the processor(s) 116 may be individually or collectively configured to receive the selection of the sensitivity level of the plurality of sensitivity levels. Further, the processor(s) 116 may detect a context trigger as valid if the similarity index between the context trigger and the reference context trigger exceeds the threshold value associated with the selected sensitivity level. Different sensitivity levels may correspond to different threshold values. As such, a context trigger that is detected as valid under one sensitivity level may be deemed invalid under a different sensitivity level, depending on whether the similarity index meets or falls below a corresponding threshold value of the selected sensitivity level.

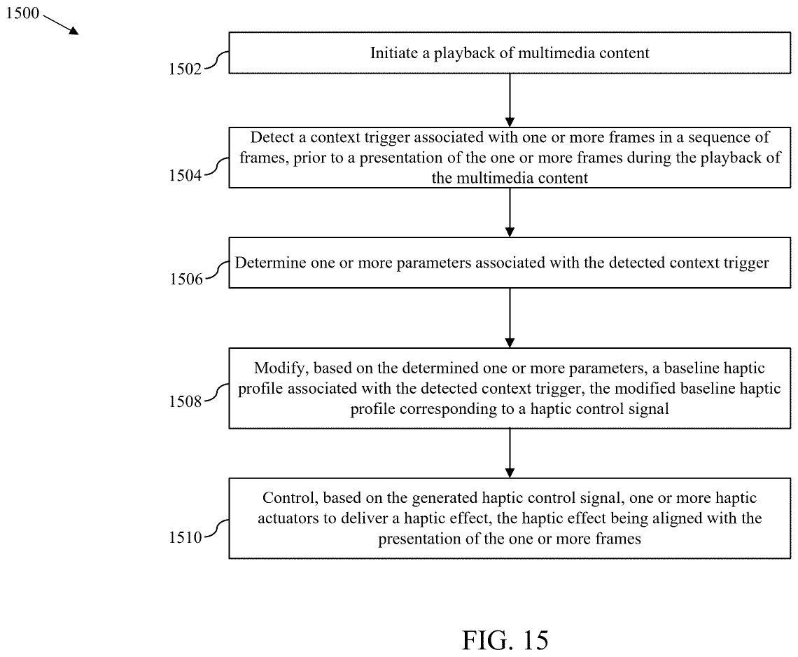

FIG. 15 is a flowchart that illustrates a method (e.g., a process 1500) for modifying a baseline haptic profile for context-aware haptics generation, in accordance with various aspects of the present disclosure. FIG. 15 is described in conjunction with FIG. 1-14. Referring to FIG. 15, there is shown a process 1500 that illustrates various example operations 1502 through 1510 for modifying a baseline haptic profile. In a non-limiting example, the process 1500 is explained with reference to the media device 100A and the haptic actuator(s) 112 of FIG. 1.

At 1502, playback of multimedia content may be initiated on a device. For example, the processor(s) 116 may be individually or collectively configured to initiate a playback of multimedia content on the media device 100A. The multimedia content may include a plurality of frames that may be presented at different times across a period of time associated with the playback of the multimedia content. In an example, a sequence of frames (e.g., the sequence of frames 140) of the plurality of frames may be stored in the buffer memory 124 prior to the presentation of the sequence of frames to enable the playback of the multimedia content.

At 1504, a context trigger associated with one or more frames in the sequence of frames 140 may be detected prior to a presentation of the one or more frames during the playback of the multimedia content. For example, the processor(s) 116 may be individually or collectively configured to detect the context trigger associated with the one or more frames in the sequence of frames 140, prior to a presentation of the one or more frames during the playback of the multimedia content. The context trigger may correspond to a visual event such as a movement-based event, an object, an impact event, a visual pattern, or a combination thereof depicted in the one or more frames. Detection of the context trigger by the processor(s) 116 is described in the foregoing description of FIG. 1-11.

At 1506, one or more parameters associated with the detected context trigger may be determined. For example, the processor(s) 116 may be individually or collectively configured to determine the one or more parameters associated with the detected context trigger. The one or more parameters may include a motion vector, a duration of the visual event, an intensity level, a frequency characteristic, a rate of change, a proximity characteristic, or a combination thereof, associated with the detected context trigger. Determination of the one or more parameters associated with the detected context trigger by the processor(s) 116 is described in the foregoing description of FIG. 1-11, more particularly in FIGS. 6A and 6B.

At 1508, based on the determined one or more parameters, a baseline haptic profile associated with the detected context trigger may be modified. For example, the processor(s) 116 may be individually or collectively configured to modify, based on the determined one or more parameters, a baseline haptic profile associated with the detected context trigger. In some examples, one or more default haptic waveforms (e.g., baseline haptic profiles) may be stored in the one or more memories 102. Upon detection of the context trigger, one default haptic waveform, that most closely corresponds to the detected context trigger, may be selected for the generation of a haptic control signal. Since the detected context trigger may not exactly match a reference context trigger associated with the selected baseline haptic profile, for example, in terms of motion vector, proximity, intensity, frequency, rate of change, or the like, the selected baseline haptic profile may be dynamically modified to reflect the specific parameters of the detected event.

For example, if the detected context trigger corresponds to a closer or more intense version of the reference context trigger (e.g., a nearby explosion rather than a distant one), the baseline haptic profile may be modified to increase the amplitude or intensity. Similarly, if the detected context trigger lasts longer or progresses differently than the reference context trigger, the duration or modulation of the baseline haptic profile may be modified. In other words, the modification of the baseline haptic profile may include a modification of at least one of an amplitude, a frequency, a duration, or an intensity of the baseline haptic profile. The modified baseline haptic profile may correspond to the generated haptic control signal. Modification of the baseline haptic profile by the processor(s) 116 is described in the foregoing description of FIG. 1-11, more particularly, in FIGS. 6A and 6B.

At 1510, based on the generated haptic control signal, one or more haptic actuators may be controlled to deliver a haptic effect. The haptic effect may be aligned with the presentation of the one or more frames. For example, the processor(s) 116 may be individually or collectively configured to control, based on the generated haptic control signal, the haptic actuator(s) 112 to deliver the haptic effect. The haptic effect may be aligned with the presentation of the one or more frames. In other words, the haptic effect may be delivered at those one or more times across the period of time, associated with the playback of the multimedia content, at which the one or more frames depicting the visual event associated with context trigger are presented. For example, if the one or more frames depicts a car moving from left to right and eventually crashing into an obstacle, the processor(s) 116 may cause the haptic actuator(s) 112 to deliver a directional haptic effect that begins with a subtle vibration on a left side of the media device 100A, gradually shifts toward a right side as the car moves across the display 106, and culminates in a strong, high-intensity burst at a time instant the collision is visually depicted. Controlling of the haptic actuator(s) 112 to deliver the haptic effect is described in the foregoing description of FIG. 1-11.

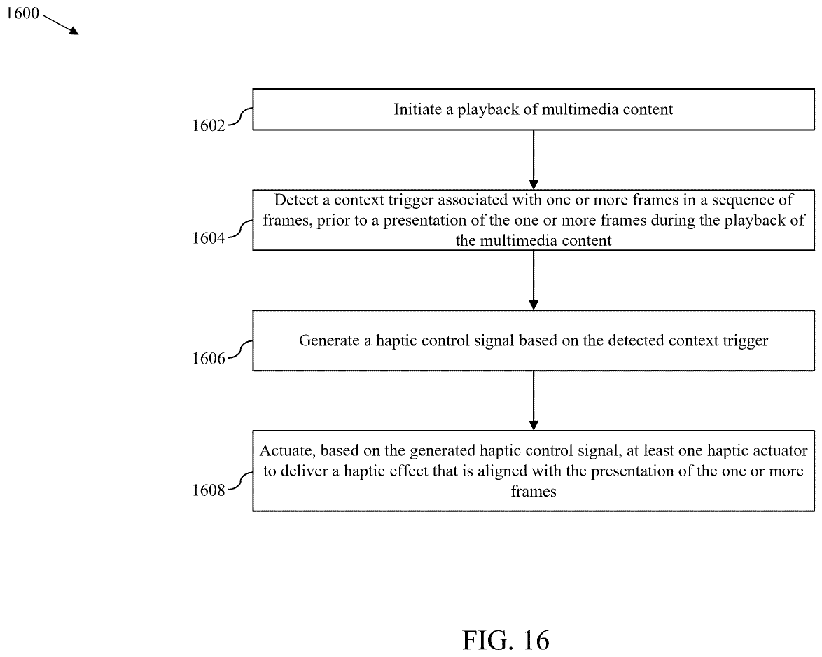

FIG. 16 is a flowchart that illustrates a method (e.g., a process) for actuating at least one haptic actuator for context-aware haptics generation, in accordance with various aspects of the present disclosure. FIG. 16 is described in conjunction with FIG. 1-15. Referring to FIG. 16, there is shown a process 1600 that illustrates various example operations 1602 through 1608 for actuating at least one haptic actuator. In a non-limiting example, the process 1600 is explained with reference to the media device 100A of FIG. 1

At 1602, playback of multimedia content may be initiated on a device. For example, the processor(s) 116 may be individually or collectively configured to initiate a playback of multimedia content on the media device 100A. The multimedia content may include a plurality of frames that may be presented at different times across a period of time associated with the playback of the multimedia content. In an example, a sequence of frames (e.g., the sequence of frames 140) of the plurality of frames may be stored in the buffer memory 124 prior to the presentation of the sequence of frames to enable the playback of the multimedia content.

At 1604, a context trigger associated with one or more frames in the sequence of frames 140 may be detected prior to a presentation of the one or more frames during the playback of the multimedia content. For example, the processor(s) 116 may be individually or collectively configured to detect the context trigger associated with the one or more frames in the sequence of frames 140, prior to the presentation of the one or more frames during the playback of the multimedia content. The context trigger may correspond to specific types of visual and/or auditory events, such as a movement-based event, an object, an impact event, a visual pattern, or a combination thereof depicted in the one or more frames. The context trigger may be identified based on a trained AI based model. For example, the trained AI based model may analyze the one or more frames before the one or more frames are presented for the detection of the context trigger. Detection of the context trigger by the processor(s) 116 is described in the foregoing description of FIG. 1-11.

At 1606, a haptic control signal may be generated based on the detected context trigger. For example, the processor(s) 116 may be individually or collectively configured to generate the haptic control signal based on the detected context trigger. In an example, the haptic control signal may correspond to a waveform that encodes various attributes (such as an amplitude, a frequency, a duration, a timing, an intensity, or a spatial location, or a combination thereof) a desired haptic effect. Generation of the haptic control signal by the processor(s) 116 is described in the foregoing description of FIG. 1-11.

At 1608, based on the generated haptic control signal, at least one haptic actuator may be actuated to deliver a haptic effect that is aligned with the presentation of the one or more frames. For example, the processor(s) 116 may be individually or collectively configured to actuate, based on the generated haptic control signal, at least one haptic actuator 112 to deliver the haptic effect. Actuation of the haptic actuator(s) 112 to deliver the haptic effect in time synchronization or time alignment with the presentation of the one or more frames is described in the foregoing description of FIG. 1-11.

Some implementation examples are described in the following numbered aspects:
Aspect 1: A method for generating context-aware haptics for multimedia content is disclosed. The method comprising detecting a context trigger associated with one or more frames in a sequence of frames, prior to a presentation of the one or more frames during playback of multimedia content. The method comprising generating a haptic control signal based on the detected context trigger. The method comprising controlling, based on the generated haptic control signal, one or more haptic actuators to deliver a haptic effect, wherein the haptic effect is aligned with the presentation of the one or more frames.
Aspect 2: The method of aspect 1, wherein the haptic control signal indicates one or more attributes associated with the haptic effect.
Aspect 3: The method of aspect 2, wherein the one or more attributes comprise at least one of an amplitude, a frequency, a duration, a timing, an intensity, or a spatial location of the haptic effect.
Aspect 4: The method of any of aspects 1 through 3, wherein the context trigger corresponds to at least one of a movement-based event, an object, an impact event, or a visual pattern depicted in the one or more frames.
Aspect 5: The method of any of aspects 1 through 4, wherein the detected context trigger is associated with a spatial characteristic, and the delivered haptic effect simulates a spatial sensation aligned with the spatial characteristic.
Aspect 6: The method of any aspects 1 through 5, wherein the detected context trigger is associated with a directional characteristic, and the delivered haptic effect simulates a directional sensation aligned with the directional characteristic.
Aspect 7: The method of any aspects 1 through 6, comprising generating the haptic control signal based on the detected context trigger and an interaction state between a user and an interface region associated with the one or more haptic actuators.
Aspect 8: The method of aspect 7, comprising receiving sensor data indicating at least one of a contact position between the user and the interface region or a grip pattern of the user, and determining the interaction state between the user and the interface region based on the received sensor data.
Aspect 9: The method of any of aspects 1 through 8, comprising detecting an engagement between a user and an interface region associated with the one or more haptic actuators at one or more times corresponding to the presentation of the one or more frames.
Aspect 10: The method of aspect 9, wherein the controlling of the one or more haptic actuators to deliver the haptic effect is responsive to the detection of the engagement between the user and the interface region at the one or more times corresponding to the presentation of the one or more frames.
Aspect 11: The method of any of aspects 1 through 10, wherein the one or more haptic actuators activate based on the haptic control signal to deliver the haptic effect that is aligned with the presentation of the one or more frames.
Aspect 12: The method of any of aspects 1 through 11, wherein the one or more haptic actuators are communicatively coupled to the device over a communication link. The method comprising transmitting the haptic control signal to the one or more haptic actuators over the communication link. The controlling of the one or more haptic actuators to deliver the haptic effect is based on the transmission of the haptic control signal.
Aspect 13: The method of any of aspects 1 through 12, wherein the detection of the context trigger is based on at least one trained artificial intelligence-based model.
Aspect 14: The method of any of aspects 1 through 13, comprising storing a plurality of reference context triggers and a plurality of baseline haptic profiles associated with the plurality of reference context triggers. The detected context trigger at least partially matches a reference context trigger of the plurality of reference context triggers. The generation of the haptic control signal is based on a baseline haptic profile, among the plurality of baseline haptic profiles, that is associated with the reference context trigger.
Aspect 15: The method of any of aspects 1 through 14, comprising storing a plurality of reference context triggers. The method comprising enabling a sensitivity adjustment option through a graphical user interface. The sensitivity adjustment option presents a plurality of sensitivity levels. The method comprising receiving a selection of a sensitivity level of the plurality of sensitivity levels. The detection of the context trigger is responsive to a similarity index between the context trigger and a reference context trigger of the plurality of reference context triggers exceeding a threshold value associated with the selected sensitivity level.
Aspect 16: The method of any of aspects 1 through 15, comprising determining one or more parameters associated with the detected context trigger; and modifying, based on the determined one or more parameters, a baseline haptic profile associated with the detected context trigger. The modified baseline haptic profile corresponds to the generated haptic control signal.
Aspect 17: The method of aspect 16, wherein the one or more parameters comprise at least one of: a motion-vector associated with the detected context trigger, a duration associated with the detected context trigger, an intensity level associated with the detected context trigger, a frequency characteristic associated with the detected context trigger, a rate of change associated with the detected context trigger, or a proximity characteristic associated with the detected context.
Aspect 18: The method of aspect 16, wherein the modification of the baseline haptic profile comprises a modification of at least one of an amplitude, a frequency, a duration, or an intensity of the baseline haptic profile.
Aspect 19: The method of any of aspects 1 through 19, comprising presenting the sequence of frames at different times across a period of time associated with the playback of the multimedia content, wherein the sequence of frames comprises the one or more frames, and the haptic effect is delivered at one or more times, across the period of time, corresponding to the presentation of the one or more frames during the playback of the multimedia content.
Aspect 20: A method for generating context-aware haptics for multimedia content is disclosed. The method comprising detecting a context trigger associated with one or more frames in a sequence of frames, prior to a presentation of the one or more frames during playback of multimedia content. The method comprising generating a haptic control signal based on the detected context trigger. The method comprising actuating, based on the generated haptic control signal, at least one haptic actuator of the one or more haptic actuators. Delivering a haptic effect that is aligned with the presentation of the one or more frames based on the actuation.
Aspect 21: A device comprising one or more memories; and one or more processors coupled to the one or more memories, the one or more processors individually or collectively configured to cause the device to perform a method of any of aspects 1 through 19.
Aspect 22: A device comprising at least one means for performing a method of any of aspects 1 through 19.
Aspect 23: A non-transitory computer-readable medium storing code for generating context-aware haptics for multimedia content at a device, the code comprising instructions executable by a processor to perform a method of any of aspects 1 through 19.
Aspect 24: A device comprising one or more haptic actuators, one or more memories; and one or more processors coupled to the one or more memories, the one or more processors individually or collectively configured to cause the device to perform a method of aspect 20.
Aspect 22: A device comprising at least one means for performing a method of aspect 20.
Aspect 23: A non-transitory computer-readable medium storing code for generating context-aware haptics for multimedia content at a device, the code comprising instructions executable by a processor to perform a method of aspect 20.

It should be noted that the methods described herein describe possible implementations, and that the operations and the steps may be rearranged or otherwise modified and that other implementations are possible. Further, aspects from two or more of the methods may be combined.

As used herein, the phrase ‘one or more processors individually or collectively configured to’ may encompass various aspects, including but not limited to: processors that are programmed and capable of performing the function, regardless of whether execution is occurring at a given time; processors actively executing instructions to perform the function; and processors that, when triggered by an event or condition, initiate execution of the function. The phrase does not limit the scope of the disclosure to an actively functioning device.

As used herein, the phrase ‘one or more processors individually or collectively configured to’ may encompass various aspects, including but not limited to: a single processor executing multiple functions; multiple processors, each performing different aspects of the function independently; multiple processors operating in coordination to execute a function collectively; or any combination thereof, where different processors may dynamically (e.g., concurrently or sequentially) assume responsibilities based on system conditions.

It is understood that the specific order or hierarchy of steps in the processes disclosed is an illustration of example approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented. Further, the examples provided throughout the present disclosure are intended for illustrative purposes and, as such, are not intended to limit the scope of the disclosure.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to a different location. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disks and discs, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A device, comprising:
one or more memories configured to store a sequence of frames associated with multimedia content; and
one or more processors coupled to the one or more memories, the one or more processors individually or collectively configured to:
detect a context trigger associated with one or more frames in the sequence of frames, prior to a presentation of the one or more frames during playback of the multimedia content;
generate a haptic control signal based on the detected context trigger; and
control, based on the generated haptic control signal, one or more haptic actuators to deliver a haptic effect, wherein the haptic effect is aligned with the presentation of the one or more frames.

2. The device of claim 1, wherein the haptic control signal indicates one or more attributes associated with the haptic effect.

3. The device of claim 2, wherein the one or more attributes comprise at least one of an amplitude, a frequency, a duration, a timing, an intensity, or a spatial location of the haptic effect.

4. The device of claim 1, wherein the context trigger corresponds to at least one of a movement-based event, an object, an impact event, or a visual pattern depicted in the one or more frames.

5. The device of claim 1, wherein
the detected context trigger is associated with a spatial characteristic, and
the delivered haptic effect simulates a spatial sensation aligned with the spatial characteristic.

6. The device of claim 1, wherein
the detected context trigger is associated with a directional characteristic, and
the delivered haptic effect simulates a directional sensation aligned with the directional characteristic.

7. The device of claim 1, wherein the one or more processors are individually or collectively configured to generate the haptic control signal based on the detected context trigger and an interaction state between a user and an interface region associated with the one or more haptic actuators.

8. The device of claim 7, wherein the one or more processors are individually or collectively configured to:
receive sensor data indicating at least one of a contact position between the user and the interface region or a grip pattern of the user; and
determine the interaction state between the user and the interface region based on the received sensor data.

9. The device of claim 1, wherein the one or more processors are individually or collectively configured to detect an engagement between a user and an interface region associated with the one or more haptic actuators at one or more times corresponding to the presentation of the one or more frames.

10. The device of claim 9, wherein the controlling of the one or more haptic actuators to deliver the haptic effect is responsive to the detection of the engagement between the user and the interface region at the one or more times corresponding to the presentation of the one or more frames.

11. The device of claim 1, comprising the one or more haptic actuators configured to activate based on the haptic control signal to deliver the haptic effect that is aligned with the presentation of the one or more frames.

12. The device of claim 1, wherein
the one or more haptic actuators are communicatively coupled to the device over a communication link, and
the one or more processors are individually or collectively configured to transmit the haptic control signal to the one or more haptic actuators over the communication link, wherein the controlling of the one or more haptic actuators to deliver the haptic effect is based on the transmission of the haptic control signal.

13. The device of claim 1, wherein the detection of the context trigger is based on at least one trained artificial intelligence-based model.

14. The device of claim 1, wherein
the one or more memories are configured to store a plurality of reference context triggers and a plurality of baseline haptic profiles associated with the plurality of reference context triggers,
the detected context trigger at least partially matches a reference context trigger of the plurality of reference context triggers, and
the generation of the haptic control signal is based on a baseline haptic profile, among the plurality of baseline haptic profiles, that is associated with the reference context trigger.

15. The device of claim 1, wherein
the one or more memories are configured to store a plurality of reference context triggers, and
the one or more processors are individually or collectively configured to:
enable a sensitivity adjustment option through a graphical user interface, wherein the sensitivity adjustment option presents a plurality of sensitivity levels; and
receive a selection of a sensitivity level of the plurality of sensitivity levels, wherein the detection of the context trigger is responsive to a similarity index between the context trigger and a reference context trigger of the plurality of reference context triggers exceeding a threshold value associated with the selected sensitivity level.

16. The device of claim 1, wherein the one or more processors are individually or collectively configured to:
determine one or more parameters associated with the detected context trigger; and
modify, based on the determined one or more parameters, a baseline haptic profile associated with the detected context trigger, wherein the modified baseline haptic profile corresponds to the generated haptic control signal.

17. The device of claim 16, wherein the one or more parameters comprise at least one of:
a motion-vector associated with the detected context trigger,
a duration associated with the detected context trigger,
an intensity level associated with the detected context trigger,
a frequency characteristic associated with the detected context trigger,
a rate of change associated with the detected context trigger, or
a proximity characteristic associated with the detected context.

18. The device of claim 16, wherein the modification of the baseline haptic profile comprises a modification of at least one of an amplitude, a frequency, a duration, or an intensity of the baseline haptic profile.

19. The device of claim 1, comprising a display configured to present the sequence of frames at different times across a period of time associated with the playback of the multimedia content, wherein
the sequence of frames comprises the one or more frames, and
the haptic effect is delivered at one or more times, across the period of time, corresponding to the presentation of the one or more frames during the playback of the multimedia content.

20. A device, comprising:
one or more haptic actuators;
one or more memories configured to store a sequence of frames associated with multimedia content; and
one or more processors coupled to the one or more memories, the one or more processors individually or collectively configured to:
detect a context trigger associated with one or more frames in the sequence of frames, prior to a presentation of the one or more frames during playback of the multimedia content;
generate a haptic control signal based on the detected context trigger; and
actuate, based on the generated haptic control signal, at least one haptic actuator of the one or more haptic actuators, wherein based on the actuation, the at least one haptic actuator is configured to deliver a haptic effect that is aligned with the presentation of the one or more frames.
